(19) United States
(12) Patent Application Publication
(10) Pub. No.: US 2026/0367366 A1
(43) Pub. Date: Nov. 19, 2026

(54) FOCUSING LENS

(71) Applicant: ZHEJIANG SUNNY OPTICS CO., LTD., Yuyao City (CN)

(72) Inventors: Yu QI, Yuyao City (CN); Yuxiang WENG, Yuyao City (CN); Rong WANG, Yuyao City (CN)

(73) Assignee: ZHEJIANG SUNNY OPTICS CO., LTD., Yuyao City (CN)

(21) Appl. No.: 19/680,487

(22) Filed: May 18, 2026

(30) Foreign Application Priority Data
May 19, 2025 (CN) 202510639221.1

(51) Int. Cl. G02B 15/14

(52) U.S. Cl. CPC G02B 15/143103

(57) ABSTRACT

A focusing lens includes three lens barrels, wherein a second lens barrel is movably disposed between a first lens barrel and a third lens barrel. The first lens barrel accommodates a first lens element, the second lens barrel accommodates second through fifth lens elements, and the third lens barrel accommodates a sixth lens element and a seventh lens element. Refractive powers of lens element groups in the three lens barrels are assigned as positive, positive, and negative, respectively. Refractive powers of the seven lens elements are assigned as positive, positive, negative, positive, positive, negative, and negative, respectively. Spacing elements are respectively disposed at image sides of the second to fourth lens elements and the sixth lens element. The focusing lens satisfies: 4.95<(F1+F2+F3)/|Δf|<5.85; and 2.35<(DT2s+DT2m)/Td2≤3.30.

### CROSS-REFERENCE TO RELATED APPLICATION

This application claims priority under 35 U.S.C. § 119 to Chinese Patent Application No. 202510639221.1, filed on May 19, 2025, the entire disclosure of which is incorporated herein by reference.

### TECHNICAL FIELD

The present application relates to the technical field of optical devices, and in particular to a focusing lens.

### BACKGROUND

In recent years, with the rapid development of smart phones, mobile phone photography has become popular among a wide range of users. Users' demand for mobile phone photography is no longer satisfied with simple recording, but begins to pursue higher imaging effects, comprising higher picture clarity, richer detail performance, and faster and more accurate focusing capabilities, which makes the importance of optical zoom technology increasingly prominent. Since an optical zoom lens element system needs to be configured with a plurality of lens element groups, the overall length of this type of system is relatively long, so it is mainly applied in periscope telephoto camera modules. The number of groups in current optical zoom systems has developed from a simple two-group configuration to a three-group configuration, and the corresponding zoom method has also developed from external focusing of the two-group configuration to internal focusing of the three-group configuration, as well as continuous zoom technology where two lens element groups in the three-group configuration focus synergistically.

Compared with external focusing and continuous zoom lens element systems, the length of the overall lens element system of an internal focusing lens element system does not change, avoiding the problem of dust and impurities being sucked in during the expansion and contraction process of the external focusing and continuous zoom lens element systems. Meanwhile, compared with the traditional external focusing system with a two-group configuration, it has higher imaging quality, and compared with the continuous zoom system with a three-group configuration, it has a shorter space occupation, a simpler and more stable module zoom structure, and a faster focusing speed. This makes the internal focusing lens element system more favored by high-end flagship mobile phones. With the market's pursuit of higher pixels and larger imaging sizes for mobile phone lenses, while also taking into account the smallest possible module height, higher requirements are put forward for the design of the focusing lens and the processability and manufacturability of the overall internal focusing lens element system.

### SUMMARY

An advantage of the present application is to provide a focusing lens, which can solve the problem that the clarity and distortion degree of an image are difficult to control when the lens changes too drastically during a focusing process.

In one aspect, the present application provides a focusing lens, comprising a first lens barrel, a second lens barrel, and a third lens barrel arranged sequentially along the same optical axis, wherein the second lens barrel is movably disposed between the first lens barrel and the third lens barrel;
a first lens element group disposed in the first lens barrel, the first lens element group comprising a first lens element having positive refractive power;
a second lens element group disposed in the second lens barrel, the second lens element group having positive refractive power and comprising a second lens element having positive refractive power, a third lens element having negative refractive power, a fourth lens element having positive refractive power, and a fifth lens element having positive refractive power;
a third lens element group disposed in the third lens barrel, the third lens element group having negative refractive power and comprising a sixth lens element having negative refractive power and a seventh lens element having negative refractive power;
wherein any adjacent two lens elements in the second lens element group comprise at least one spacing element therebetween, and the object-side surface of the spacing element is in contact with the adjacent lens element;
wherein the focusing lens satisfies: 4.95<(F1+F2+F3)/|Δf|<5.85; and 2.35≤(DT2s+DT2m)/Td2≤3.30;
wherein F1 is the effective focal length of the first lens element group, F2 is the effective focal length of the second lens element group, and F3 is the effective focal length of the third lens element group; Δf is a change of the effective focal length of the focusing lens when the second lens barrel moves from a position closest to the first lens barrel to a position closest to the third lens barrel; DT2s is the clear aperture of the second lens barrel at the object side, and DT2m is the clear aperture of the second lens barrel at the image side; and Td2 is a distance on the optical axis from the object-side surface of the second lens element to the image-side surface of the fifth lens element in the second lens element group.

In some embodiments of the present application, the second lens barrel satisfies: 0.80≤DT2s/DT2m<1.40;
wherein DT2s is the clear aperture of the second lens barrel at the object side, and DT2m is the clear aperture of the second lens barrel at the image side.

In some embodiments of the present application, the focusing lens satisfies: 2.10<F2/L2≤2.95; and 2.10≤F2/Td2≤2.85;
wherein F2 is the effective focal length of the second lens element group, L2 is the maximum height of the second lens barrel, and Td2 is a distance on the optical axis from the object-side surface of the second lens element to the image-side surface of the fifth lens element in the second lens element group.

In some embodiments of the present application, a second spacing element is disposed at the image side of the second lens element and in contact with the image-side surface of the second lens element, and the focusing lens further satisfies: 1.65≤f2/d2s<5.20;
wherein f2 is the effective focal length of the second lens element, and d2s is the inner diameter of the object-side surface of the second spacing element.

In some embodiments of the present application, a third spacing element is disposed at the image side of the third lens element and in contact with the image-side surface of the third lens element, and the focusing lens further satisfies: 0.50<(f3+f4)/d3s<2.15;
wherein f3 is the effective focal length of the third lens element, f4 is the effective focal length of the fourth lens element, and d3s is the inner diameter of the object-side surface of the third spacing element.

In some embodiments of the present application, a fourth spacing element is disposed at the image side of the fourth lens element and in contact with the image-side surface of the fourth lens element, and the focusing lens further satisfies: 2.15<f4/d4m<3.45;
wherein f4 is the effective focal length of the fourth lens element, and d4m is the inner diameter of the image-side surface of the fourth spacing element.

In some embodiments of the present application, the focusing lens further satisfies: 4.95≤DT2m/(CT5×N5)<11.95;
wherein DT2m is the clear aperture of the second lens barrel at the image side, CT5 is the center thickness of the fifth lens element, and N5 is the refractive index of the fifth lens element.

In some embodiments of the present application, the focusing lens further satisfies: 3.35<DT2s/(CT2×N2)<6.45;
wherein DT2s is the clear aperture of the second lens barrel at the object side, CT2 is the center thickness of the second lens element, and N2 is the refractive index of the second lens element.

In some embodiments of the present application, the focusing lens satisfies: −3.50<F3/L3≤−2.55; and 0.80≤Td3/L3<0.95;
wherein L3 is the maximum height of the third lens barrel along the direction of the optical axis, F3 is the effective focal length of the third lens element group, and Td3 is a distance on the optical axis from the object-side surface of the sixth lens element to the image-side surface of the seventh lens element in the third lens element group.

In some embodiments of the present application, the focusing lens further satisfies: 3.65<F3|/(L3-T67)≤5.10;
wherein F3 is the effective focal length of the third lens element group, L3 is the maximum height of the third lens barrel along the direction of the optical axis, and T67 is an air gap between the sixth lens element and the seventh lens element on the optical axis.

In some embodiments of the present application, the focusing lens further satisfies: 0.40<ET6/(CT6+T67)≤0.95;
wherein ET6 is the maximum thickness of a non-transmissive area of the sixth lens element, CT6 is the center thickness of the sixth lens element, and T67 is an air gap between the sixth lens element and the seventh lens element on the optical axis.

In some embodiments of the present application, the focusing lens further satisfies: 0.35<ET7/(T67+CT7)<1.10;
wherein ET7 is the maximum thickness of a non-transmissive area of the seventh lens element, CT7 is the center thickness of the seventh lens element, and T67 is an air gap between the sixth lens element and the seventh lens element on the optical axis.

In some embodiments of the present application, the focusing lens satisfies: 1.45<F1/F2<2.45; and −3.60<F1/F3≤−2.10;
wherein F1 is the effective focal length of the first lens element group, F2 is the effective focal length of the second lens element group, and F3 is the effective focal length of the third lens element group.

In some embodiments of the present application, the focusing lens further satisfies: 1.70≤(T12+T56)/ΔEP0<2.20;
wherein T12 is an air gap between the first lens element and the second lens element on the optical axis, T56 is an air gap between the fifth lens element and the sixth lens element on the optical axis, and ΔEP0 is the maximum distance that the second lens barrel is movable along the direction of the optical axis.

In some embodiments of the present application, the focusing lens further satisfies: 4.40<(L1+L2+L3)/ΔEP0<5.55;
wherein L1 is the maximum height of the first lens barrel along the direction of the optical axis, L2 is the maximum height of the second lens barrel along the direction of the optical axis, L3 is the maximum height of the third lens barrel along the direction of the optical axis, and ΔEP0 is the maximum distance that the second lens barrel is movable along the direction of the optical axis.

In summary, the focusing lens of the present application adopts a combined structure of three lens barrels, wherein the first to third lens barrels respectively accommodate the first to third lens element groups; wherein the first lens element group comprises the first lens element, the second lens element group comprises the second lens element to the fifth lens element, and the third lens element group comprises the sixth lens element and the seventh lens element; by sequentially assigning the refractive powers of the three lens element groups according to “positive-positive-negative” and sequentially assigning the refractive powers of the first to seventh lens elements according to “positive-positive-negative-positive-positive-negative-negative”, and further by arranging the second lens barrel to be movable along the direction of the optical axis between the first lens barrel and the third lens barrel, the focusing lens achieves balanced imaging performance across different focal length ranges including telephoto, close focus, and macro, etc.; and by controlling a ratio relationship between the sum of focal lengths of the three lens element groups and the maximum change in effective focal length of the focusing lens, the focusing lens balances both a focusing range and imaging quality. On one hand, constraining a lower limit of the ratio enables the focusing range of the focusing lens to cover demands for different focal lengths in actual use; on the other hand, when a change in effective focal length of the focusing lens is too drastic, the clarity, distortion, etc., of an image are difficult to control during the focusing process, and constraining the upper limit of the ratio can reduce the influence of an excessively fast change in effective focal length of the focusing lens during the focusing process on imaging quality; further, the ratio of the sum of the clear aperture of the object side and the clear aperture of the second lens barrel at the image side in the second lens element group to the distance on the optical axis from the object-side surface of the second lens element to the image-side surface of the fifth lens element is controlled to be within a reasonable range; on one hand, appropriate clear apertures can ensure a light intake amount of the optical system in the focusing lens, ensuring brightness, contrast, and high performance of imaging; on the other hand, an appropriate distance on the optical axis from the object-side surface of the second lens element to the image-side surface of the fifth lens element makes the overall structure of the optical system compact, which is conducive to miniaturization of the focusing lens.

### BRIEF DESCRIPTION OF DRAWINGS

FIG. 1 is a schematic structural diagram of a focusing lens according to the present application;

FIG. 2 is a schematic dimensional diagram of the focusing lens shown in FIG. 1;

FIG. 3A is a schematic structural diagram of a focusing lens in configuration 1-1 in the first embodiment according to the present application;

FIG. 3B is a schematic structural diagram of a focusing lens in configuration 1-2 in the first embodiment according to the present application;

FIG. 3C is a schematic structural diagram of a focusing lens in configuration 1-3 in the first embodiment according to the present application;

FIG. 4A is an axial chromatic aberration curve diagram of the focusing lens in the three configurations of the first embodiment when the object distance is infinity;

FIG. 4B is an astigmatism curve diagram of the focusing lens in the three configurations of the first embodiment when the object distance is infinity;

FIG. 4C is a distortion curve diagram of the focusing lens in the three configurations of the first embodiment when the object distance is infinity;

FIG. 5A is an axial chromatic aberration curve diagram of the focusing lens in the three configurations of the first embodiment when the object distance is 57.8556 mm;

FIG. 5B is an astigmatism curve diagram of the focusing lens in the three configurations of the first embodiment when the object distance is 57.8556 mm;

FIG. 5C is a distortion curve diagram of the focusing lens in the three configurations of the first embodiment when the object distance is 57.8556 mm;

FIG. 6A is a schematic structural diagram of a focusing lens in configuration 2-1 in the second embodiment according to the present application;

FIG. 6B is a schematic structural diagram of a focusing lens in configuration 2-2 in the second embodiment according to the present application;

FIG. 6C is a schematic structural diagram of a focusing lens in configuration 2-3 in the second embodiment according to the present application;

FIG. 7A is an axial chromatic aberration curve diagram of the focusing lens in the three configurations of the second embodiment when the object distance is infinity;

FIG. 7B is an astigmatism curve diagram of the focusing lens in the three configurations of the second embodiment when the object distance is infinity;

FIG. 7C is a distortion curve diagram of the focusing lens in the three configurations of the second embodiment when the object distance is infinity;

FIG. 8A is an axial chromatic aberration curve diagram of the focusing lens in the three configurations of the second embodiment when the object distance is 52.6455 mm;

FIG. 8B is an astigmatism curve diagram of the focusing lens in the three configurations of the second embodiment when the object distance is 52.6455 mm;

FIG. 8C is a distortion curve diagram of the focusing lens in the three configurations of the second embodiment when the object distance is 52.6455 mm;

FIG. 9A is a schematic structural diagram of a focusing lens in configuration 3-1 in the third embodiment according to the present application;

FIG. 9B is a schematic structural diagram of a focusing lens in configuration 3-2 in the third embodiment according to the present application;

FIG. 9C is a schematic structural diagram of a focusing lens in configuration 3-3 in the third embodiment according to the present application;

FIG. 10A is an axial chromatic aberration curve diagram of the focusing lens in the three configurations of the third embodiment when the object distance is infinity;

FIG. 10B is an astigmatism curve diagram of the focusing lens in the three configurations of the third embodiment when the object distance is infinity;

FIG. 10C is a distortion curve diagram of the focusing lens in the three configurations of the third embodiment when the object distance is infinity;

FIG. 11A is an axial chromatic aberration curve diagram of the focusing lens in the three configurations of the third embodiment when the object distance is 66.6675 mm;

FIG. 11B is an astigmatism curve diagram of the focusing lens in the three configurations of the third embodiment when the object distance is 66.6675 mm;

FIG. 11C is a distortion curve diagram of the focusing lens in the three configurations of the third embodiment when the object distance is 66.6675 mm;

FIG. 12 is a schematic diagram of MTF curves when the focusing lens satisfies (F1+F2+F3)/|Δf|=5.58;

FIG. 13 is a schematic diagram of MTF curves when the focusing lens satisfies (F1+F2+F3)/|Δf|=4.35; and

FIG. 14 is a schematic diagram of MTF curves when the focusing lens satisfies (F1+F2+F3)/|Δf|=8.22.

### REFERENCE SIGNS

E1, First lens element; E2, Second lens element; E3, Third lens element; E4, Fourth lens element; E5, Fifth lens element; E6, Sixth lens element; E7, Seventh lens element; P01, First lens barrel; P02, Second lens barrel; P03, Third lens barrel; P2, Second spacing element; P3, Third spacing element; P4, Fourth spacing element; P6, Sixth spacing element; E8, Prism; E9, Filter.

### DETAILED DESCRIPTION

In order to better understand the present application, various aspects of the present application will be described in more detail with reference to the accompanying drawings. It should be understood that these detailed descriptions are merely descriptions of exemplary embodiments of the present application, and are not intended to limit the scope of the present application in any way. Throughout the specification, the same reference numerals refer to the same elements. The expression “and/or” comprises any and all combinations of one or more of the associated listed items.

It should be noted that in this specification, the expressions first, second, third, etc., are only used to distinguish one feature from another feature, and do not represent any limitation on the features. Therefore, without departing from the teachings of the present application, the first lens element E1 discussed below may also be referred to as a second lens element E2 or a third lens element E3.

In the drawings, for ease of explanation, the thickness, size, and shape of the lens elements have been slightly exaggerated. Specifically, the shapes of spherical surfaces or aspheric surfaces shown in the drawings are shown by way of example. That is, the shapes of spherical surfaces or aspheric surfaces are not limited to the spherical or aspheric shapes shown in the drawings. The drawings are only examples and are not strictly drawn to scale.

Herein, the paraxial region refers to a region near the optical axis. If a lens element surface is a convex surface and the position of the convex surface is not defined, it indicates that the lens element surface is convex at least in the paraxial region; if a lens element surface is a concave surface and the position of the concave surface is not defined, it indicates that the lens element surface is concave at least in the paraxial region. The judgment of the surface profile in the paraxial region can be judged according to a general method in the art, for example, judging concavity and convexity by the sign of an R value (R refers to a radius of curvature in the paraxial region). Herein, the surface of each lens element closest to the photographed object is referred to as the object-side surface of the lens element, and the surface of each lens element closest to the imaging plane is referred to as the image-side surface of the lens element. Regarding the object-side surface, when the R value is positive, it is judged as a convex surface, and when the R value is negative, it is judged as a concave surface; regarding the image-side surface, when the R value is positive, it is judged as a concave surface, and when the R value is negative, it is judged as a convex surface.

It should also be understood that the terms “comprise”, “comprise of”, “have”, “contain” and/or “contain of”, when used in this specification, indicate the presence of stated features, elements, and/or components, but do not exclude the presence or addition of one or more other features, elements, components, and/or combinations thereof. In addition, when an expression such as “at least one of . . . ” appears after a list of listed features, it modifies the entire list of listed features, rather than modifying individual elements in the list. In addition, when describing embodiments of the present application, the use of “may” represents “one or more embodiments of the present application”. Also, the term “exemplary” is intended to refer to an example or illustration.

Unless otherwise defined, all terms (comprising technical terms and scientific terms) used herein have the same meaning as commonly understood by those of ordinary skill in the art to which the present application belongs. It should also be understood that terms (e.g., terms defined in commonly used dictionaries) should be interpreted as having meanings consistent with their meanings in the context of the relevant technology, and will not be interpreted in an idealized or overly formalized sense, unless explicitly so defined herein.

It should be noted that in the case of no conflict, the embodiments in the present application and the features in the embodiments can be combined with each other. The following embodiments only express several implementations of the present application, and the descriptions thereof are relatively specific and detailed, but they cannot be understood as a limitation on the patent scope of the present application. It should be pointed out that for those of ordinary skill in the art, several deformations and improvements can be made without departing from the concept of the present application, all of which belong to the protection scope of the present application. The present application will be described in detail below with reference to the accompanying drawings and in conjunction with embodiments.

It is worth noting that in the present application, the non-transmissive area of a lens element is located at the edge of the lens element. This area is mainly used for contact with a lens barrel or a spacing element to play a role in supporting the lens element. The edge thickness of the lens element is the thickness of the non-transmissive area along the direction of the optical axis.

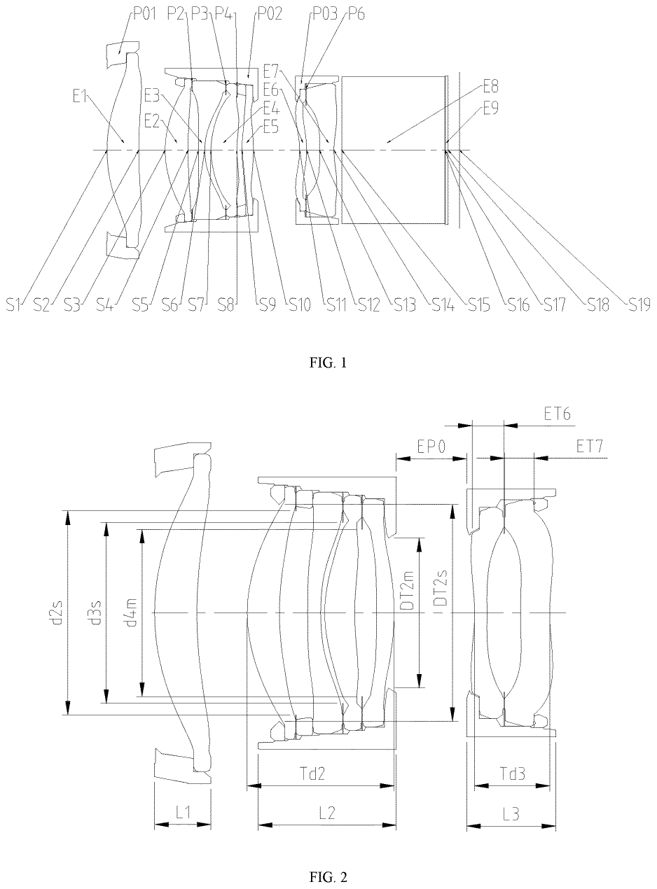

According to an aspect of the present application, as shown in FIG. 1 and FIG. 2, wherein FIG. 1 is a schematic structural diagram of a focusing lens according to the present application, and FIG. 2 is a schematic dimensional diagram of the focusing lens shown in FIG. 1, an embodiment of the present application proposes a focusing lens, which may comprise a first lens barrel, a second lens barrel, and a third lens barrel arranged sequentially along the same optical axis, wherein the second lens barrel is movably disposed between the first lens barrel and the third lens barrel;
a first lens element group disposed in the first lens barrel P01, the first lens element group comprising a first lens element E1 having positive refractive power;
a second lens element group disposed in the second lens barrel P02, the second lens element group having positive refractive power and comprising a second lens element E2 having positive refractive power, a third lens element E3 having negative refractive power, a fourth lens element E4 having positive refractive power, and a fifth lens element E5 having positive refractive power;
a third lens element group disposed in the third lens barrel P03, the third lens element group having negative refractive power and comprising a sixth lens element E6 having negative refractive power and a seventh lens element E7 having negative refractive power;
wherein any adjacent two lens elements in the second lens element group comprise at least one spacing element therebetween, and the object-side surface of the spacing element is in contact with the adjacent lens element;
wherein the focusing lens satisfies: 4.95<(F1+F2+F3)/|Δf|<5.85; and 2.35≤(DT2s+DT2m)/Td2≤3.30;
wherein F1 is the effective focal length of the first lens element group, F2 is the effective focal length of the second lens element group, and F3 is the effective focal length of the third lens element group; Δf is a change of the effective focal length of the focusing lens when the second lens barrel P02 moves from a position closest to the first lens barrel P01 to a position closest to the third lens barrel P03; DT2s is the clear aperture of the second lens barrel P02 at the object side, and DT2m is the clear aperture of the second lens barrel P02 at the image side; and Td2 is a distance on the optical axis from the object-side surface of the second lens element E2 to the image-side surface of the fifth lens element E5 in the second lens element group.

It is worth noting that the focusing lens of the present application adopts a combined structure of three lens barrels, wherein the first to third lens barrels respectively accommodate the first to third lens element groups; wherein the first lens element group comprises the first lens element E1, the second lens element group comprises the second lens element E2 to the fifth lens element E5, and the third lens element group comprises the sixth lens element E6 and the seventh lens element E7; by sequentially assigning the refractive powers of the three lens element groups according to “positive-positive-negative” and sequentially assigning the refractive powers of the first to seventh lens elements according to “positive-positive-negative-positive-positive-negative-negative”, and further by arranging the second lens barrel to be movable along the direction of the optical axis between the first lens barrel and the third lens barrel, the focusing lens achieves balanced imaging performance across different focal length ranges including telephoto, close focus, and macro, etc.; and by controlling a ratio relationship between the sum of focal lengths of the three lens element groups and the maximum change in effective focal length of the focusing lens, the focusing lens balances both a focusing range and imaging quality. On one hand, constraining a lower limit of the ratio enables the focusing range of the focusing lens to cover demands for different focal lengths in actual use; on the other hand, when a change in effective focal length of the focusing lens is too drastic, the clarity, distortion, etc., of an image are difficult to control during the focusing process, and constraining the upper limit of the ratio can reduce the influence of an excessively fast change in effective focal length of the focusing lens during the focusing process on imaging quality; further, the ratio of the sum of the clear apertures of the second lens barrel P02 at the object side and at the image side to the distance on the optical axis from the object-side surface of the second lens element E2 to the image-side surface of the fifth lens element E5 in the second lens element group is controlled to be within a reasonable range; on one hand, appropriate clear apertures can ensure a light intake amount of the optical system in the focusing lens, ensuring brightness, contrast, and high performance of imaging; on the other hand, an appropriate distance on the optical axis from the object-side surface of the second lens element E2 to the image-side surface of the fifth lens element E5 makes the overall structure of the optical system compact, which is conducive to miniaturization of the focusing lens.

In addition, the object-side surface of the first lens element E1 is a convex surface; the object-side surface of the second lens element E2 is a convex surface; the image-side surface of the third lens element E3 is a concave surface; the object-side surface of the fourth lens element E4 is a convex surface, and the image-side surface thereof is a concave surface; the image-side surface of the fifth lens element E5 is a convex surface; the object-side surface of the sixth lens element E6 is a concave surface, and the image-side surface thereof is a convex surface; and the object-side surface of the seventh lens element E7 is a convex surface, and the image-side surface thereof is a concave surface.

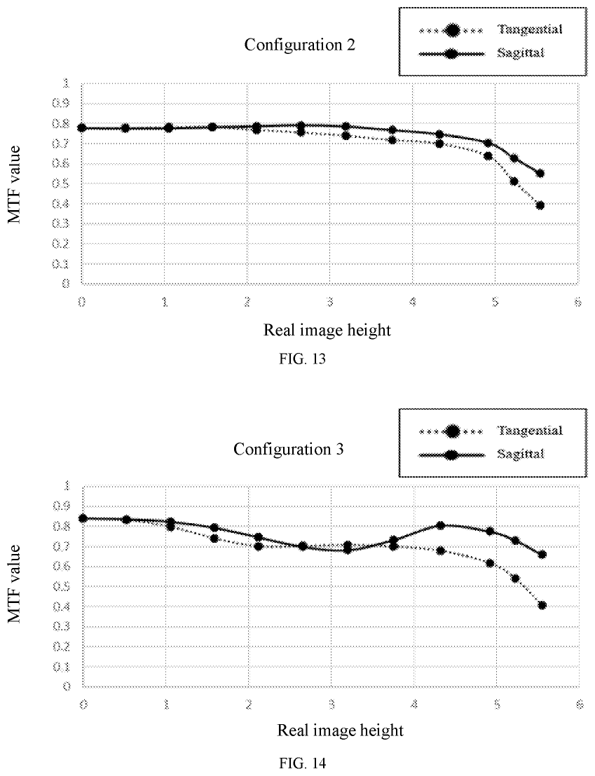

Exemplarily, the present application provides MTF curve diagrams under three cases, wherein the first case corresponds to FIG. 12, the second case corresponds to FIG. 13, and the third case corresponds to FIG. 14. FIG. 12 illustrates MTF curves and modulation transfer function curves when the focusing lens satisfies (F1+F2+F3)/|Δf|=5.58; FIG. 13 illustrates MTF curves and modulation transfer function curves when the focusing lens satisfies (F1+F2+F3)/|Δf|=4.35; and FIG. 14 illustrates MTF curves and modulation transfer function curves when the focusing lens satisfies (F1+F2+F3)/|Δf|=8.22.

It can be easily known from the figures that: as shown in FIG. 12, in the first case, when the relational expression (F1+F2+F3)/|Δf| is in a range greater than 4.95 and less than 6.25, the MTF curve of the focusing lens is stable, enabling the focusing lens to have good MTF performance; as shown in FIG. 13, in the second case, when the relational expression (F1+F2+F3)/|Δf| is in a range less than 4.95, as the image height increases, especially when the image height is greater than 5 mm, the MTF curve of the focusing lens shows a significant drop, and the optical performance degrades and does not meet imaging requirements; as shown in FIG. 14, in the third case, when the relational expression (F1+F2+F3)/|Δf| is greater than 5.80, as the image height increases, the MTF of the focusing lens shows significant fluctuations, and shows a significant drop when the image height is greater than 5 mm, and the optical performance degrades and does not meet imaging requirements.

Preferably, the focusing lens satisfies: 4.97≤(F1+F2+F3)/|Δf| 5.84, and 2.35≤(DT2s+DT2m)/Td2≤3.26.

According to some embodiments of the present application, the second lens barrel P02 further satisfies: 0.80≤DT2s/DT2m<1.40;
wherein DT2s is the clear aperture of the second lens barrel P02 at the object side, and DT2m is the clear aperture of the second lens barrel P02 at the image side.

In this way, by reasonably limiting the ratio range of the clear aperture of the second lens barrel P02 at the object side to the clear aperture of the second lens barrel P02 at the image side, firstly, it is ensured that light rays are relatively uniform when passing through the second lens element group, avoiding loss of marginal rays which causes the edge part of imaging to be darker than the central part, forming imaging vignetting and affecting overall image quality; secondly, during a zoom movement process of the second lens element group, changes such as illuminance can also be kept small, avoiding obvious separation of brightness and darkness during the zoom process, which affects continuous effects in zoom shooting; furthermore, by constraining the upper limit of the ratio, stray light can also be reduced, because if the clear aperture of the lens barrel at the object side is too large relative to the clear aperture of the lens barrel at the image side, more non-imaging light rays may enter the system, forming a stray light background on the image plane, reducing imaging contrast and affecting imaging effects.

Preferably, the second lens barrel P02 satisfies: 0.8≤DT2s/DT2m≤1.39.

According to some embodiments of the present application, the focusing lens further satisfies: 2.10<F2/L2≤2.95 and 2.10≤F2/Td2≤2.85;
wherein F2 is the effective focal length of the second lens element group, L2 is the maximum height of the second lens barrel P02, and Td2 is a distance on the optical axis from the object-side surface of the second lens element E2 to the image-side surface of the fifth lens element E5 in the second lens element group.

In this way, reasonably controlling the ratio of the effective focal length of the second lens element group to the maximum height of the second lens barrel P02 helps to ensure the mechanical stability of the optical system. Firstly, when the ratio is within a reasonable range, the size proportion between the second lens barrel P02 and the second lens element group is well-balanced, which facilitates installation and fixation. This reduces issues such as vibration and misalignment caused by structural instability, thereby improving the reliability and stability of the system; secondly, further limiting the ratio of the effective focal length of the second lens element group to the distance on the optical axis from the object-side surface of the second lens element E2 to the image-side surface of the fifth lens element E5 can keep aberrations at a good level; if the distance Td2 is too short, propagation angles of light rays change drastically between lens element groups, increasing the difficulty of aberration correction, and possibly producing spherical aberration, coma, etc.; furthermore, problems such as edge blurring and deformation when photographing distant objects are avoided; if the effective focal length is too long while the distance Td2 is relatively too short, a convergence or divergence degree of light rays exceeds a correction capability of the lens element groups, which will also degrade image quality.

Preferably, the focusing lens satisfies: 2.13≤F2/L2≤2.95 and 2.10≤F2/Td2≤2.85.

According to some embodiments of the present application, a second spacing element P2 is disposed at the image side of the second lens element E2 and in contact with the image-side surface of the second lens element E2, and the focusing lens further satisfies: 1.65≤f2/d2s<5.20;
wherein f2 is the effective focal length of the second lens element E2, and d2s is the inner diameter of the object-side surface of the second spacing element P2.

In this way, reasonably limiting the ratio of the effective focal length of the second lens element E2 to the inner diameter of the object-side surface of the second spacing element P2 can reduce optical loss and assembly sensitivity of the second lens element E2. When the ratio is too large, the second spacing element P2 intercepts too many light rays, causing loss of light energy and reducing brightness and contrast of the image plane. When the ratio is too small, a convergence or divergence capability of the second lens element E2 on light rays is too drastic, causing sensitivity of the second lens element E2 to be too high, requiring excessively high requirements for the second lens element E2 during the assembly process, affecting the yield rate of the second lens element group, and further affecting the yield rate of the entire focusing lens.

Preferably, the focusing lens satisfies: 1.65≤f2/d2s≤5.18.

According to some embodiments of the present application, a third spacing element P3 is disposed at the image side of the third lens element E3 and in contact with the image-side surface of the third lens element E3, and the focusing lens further satisfies: 0.50<(f3+f4)/d3s<2.15;
wherein f3 is the effective focal length of the third lens element E3, f4 is the effective focal length of the fourth lens element E4, and d3s is the inner diameter of the object-side surface of the third spacing element P3.

In this way, reasonably controlling the ratio of the sum of the effective focal length of the third lens element E3 and the effective focal length of the fourth lens element E4 to the inner diameter of the object-side surface of the third spacing element P3 makes transition light rays passing through the second lens system E2 more stable, and can correct aberrations. On one hand, under the condition that the inner diameter of the object-side surface of the third spacing element P3 is constant, when the ratio is relatively small, that is, when the sum of the effective focal lengths of the third lens element E3 and the fourth lens element E4 is relatively small, deflection capabilities of the third lens element E3 and the fourth lens element E4 on light rays are too strong, which easily causes light rays to generate large aberrations, such as coma, astigmatism, etc., at the inner edge of the third spacing element P3, leading to a phenomenon of distortion and blurring at the edge of image imaging; conversely, when the ratio is too large, deflection effects of the third lens element E3 and the fourth lens element E4 on light rays are insufficient, and correction is insufficient when light rays propagate, which will also degrade image quality. On the other hand, under the condition that the effective focal lengths of the third lens element E3 and the fourth lens element E4 are constant, if the inner diameter of the object-side surface of the third spacing element P3 is relatively larg, excess light rays will be introduced to form stray light, affecting imaging quality; if it is too small, interception will affect illuminance, forming a steep drop in illuminance at the edge of the image plane to form vignetting, affecting imaging effects.

Preferably, the focusing lens satisfies: 0.51≤(f3+f4)/d3s≤2.14.

According to some embodiments of the present application, a fourth spacing element P4 is disposed at the image side of the fourth lens element E4 and in contact with the image-side surface of the fourth lens element E4, and the focusing lens further satisfies: 2.15<f4/d4m<3.45;
wherein f4 is the effective focal length of the fourth lens element E4, and d4m is the inner diameter of the image-side surface of the fourth spacing element P4.

In this way, reasonably limiting the ratio of the effective focal length of the fourth lens element E4 to the inner diameter of the image-side surface of the fourth spacing element P4 enables more precise control over the effective focal length of the fourth lens element E4, thereby controlling the quantity and path of light rays passing through the fourth lens element E4 and the inner diameter of the fourth spacing element P4. Keeping the effective focal length of the fourth lens element E4 within an appropriate range can ensure the magnitude of overall illuminance, and keeping the inner diameter of the image-side surface of the fourth spacing element P4 within an appropriate range can control the amount of marginal rays passing through, thereby ensuring the magnitude of marginal illuminance. This achieves an improved imaging effect with a smooth overall illuminance distribution free of inflections or steep drops.

Preferably, the focusing lens satisfies: 2.16≤f4/d4m≤3.42.

According to some embodiments of the present application, the focusing lens further satisfies: 4.95≤DT2m/(CT5×N5)<11.95;
wherein DT2m is the clear aperture of the second lens barrel P02 at the image side, CT5 is the center thickness of the fifth lens element E5, and N5 is the refractive index of the fifth lens element E5.

In this way, reasonably limiting the ratio of the clear aperture of the second lens barrel P02 at the image side to the center thickness of the fifth lens element E5 and the refractive index of the fifth lens element E5, on one hand, reasonably allocates the optical path of light rays within the center thickness of the fifth lens element E5 (i.e., the optical path at the center of the fifth lens element E5) under the condition that the clear aperture of the second lens barrel P02 at the image side is constant, making room for the respective lens elements of the second lens element group; under the condition that the center thickness and refractive index of the fifth lens element E5 are constant, an exit light ray aperture of the second lens element group is controlled to ensure sufficient exit light rays while intercepting excess stray light rays; on the other hand, it facilitates the assembly of the second lens element group and improves assembly accuracy; when the ratio is appropriate, the sizes of the second lens barrel P02 and the fifth lens element E5 are reasonably matched, allowing for the use of conventional assembly processes, which can ensure the concentricity and relative positional accuracy between the lens element and the lens barrel, thereby minimizing the impact of assembly errors on optical performance.

Preferably, the focusing lens satisfies: 4.95≤DT2m/(CT5×N5)≤11.93.

According to some embodiments of the present application, the focusing lens further satisfies: 3.35<DT2s/(CT2×N2)<6.45;
wherein DT2s is the clear aperture of the second lens barrel P02 at the object side, CT2 is the center thickness of the second lens element E2, and N2 is the refractive index of the second lens element E2.

In this way, similarly, reasonably limiting the ratio of the clear aperture of the second lens barrel P02 at the object side to the center thickness of the second lens element E2 and the refractive index of the second lens element E2, on one hand, reasonably allocates the optical path of light rays within the center thickness of the second lens element E2 (i.e., the optical path at the center of the second lens element E2) under the condition that the clear aperture of the second lens barrel P02 at the object side is constant, making room for the other respective lens elements in the second lens element group; under the condition that the optical path in the second lens element E2 is constant, an incident light ray angle of the second lens element group is controlled to ensure sufficient incident light rays while intercepting excess stray light rays. On the other hand, it is conducive to improving assembly convenience and accuracy of the second lens element group. When the ratio is suitable, the sizes of the second lens barrel P02 and the second lens element E2 are reasonably matched, allowing for the use of conventional assembly processes, which can ensure the concentricity and relative positional accuracy between the lens element and the lens barrel, thereby minimizing the impact of assembly errors on optical performance.

Preferably, the focusing lens satisfies: 3.39≤DT2s/(CT2×N2)≤6.42.

According to some embodiments of the present application, the focusing lens satisfies: −3.50<F3/L3≤−2.55 and 0.80≤Td3/L3<0.95;
wherein L3 is the maximum height of the third lens barrel P03 along the direction of the optical axis, F3 is the effective focal length of the third lens element group, and Td3 is a distance on the optical axis from the object-side surface of the sixth lens element E6 to the image-side surface of the seventh lens element E7 in the third lens element group.

In this way, reasonably controlling the ratio of the effective focal length of the third lens element group to the maximum height of the third lens barrel P03 along the direction of the optical axis helps to ensure the mechanical stability of the optical system. When the ratio is within a reasonable range, the size proportion between the third lens barrel P03 and the third lens element group is well-balanced, which facilitates installation and fixation. This reduces issues such as vibration and misalignment caused by structural instability, thereby improving the reliability and stability of the system. Further limiting the ratio of the distance on the optical axis from the object-side surface of the sixth lens element E6 to the image-side surface of the seventh lens element E7 to the maximum height of the third lens barrel P03 along the direction of the optical axis ensures that the third lens element group does not protrude from the outer end of the lens barrel as much as possible when assembled inside the third lens barrel P03; even if it protrudes, only the object-side surface of the third lens element group is allowed to protrude slightly toward the second lens element group, avoiding collision of the third lens element group with the second lens element group or with other module structures located on the image side of the third lens element group (such as the prism E8 and filter E9 in FIG. 1) caused by excessive protrusion from the third lens barrel P03, which would otherwise result in appearance defects and losses.

Preferably, the focusing lens satisfies: −3.49≤F3/L3≤−2.55 and 0.8≤Td3/L3≤0.92.

According to some embodiments of the present application, the focusing lens further satisfies: 3.65<|F3|/(L3−T67)≤5.10;
wherein F3 is the effective focal length of the third lens element group, L3 is the maximum height of the third lens barrel P03 along the direction of the optical axis, and T67 is an air gap between the sixth lens element E6 and the seventh lens element E7 on the optical axis.

In this way, reasonably limiting the ratio range of the effective focal length of the third lens element group to the difference between the maximum height of the third lens barrel P03 and the air gap between the sixth lens element E6 and the seventh lens element E7 on the optical axis, on one hand, is conducive to ensuring space for the thickness for the sixth lens element E6 and the seventh lens element E7, ensuring strength and processability of the two lens elements; furthermore, an appropriate air gap can also ensure stability of the third lens element group. On the other hand, light rays from the entire optical system exit through the third lens element group to the image plane. Controlling the effective focal length of the third lens element group facilitates the correction of aberrations. If light rays refracted by the third lens element group are excessively converged or divergent and emerge directly onto the image plane, aberrations such as spherical aberration and coma will increase. This leads to reduced resolution and an inability to resolve image details, thereby affecting imaging clarity.

Preferably, the focusing lens satisfies: 3.69≤|F3|/(L3−T67)≤5.10.

According to some embodiments of the present application, the focusing lens further satisfies: 0.40<ET6/(CT6+T67)≤0.95;
wherein ET6 is the maximum thickness of a non-transmissive area of the sixth lens element E6, CT6 is the center thickness of the sixth lens element E6, and T67 is an air gap between the sixth lens element E6 and the seventh lens element E7 on the optical axis.

In this way, reasonably controlling the ratio of the maximum thickness of the non-transmissive area of the sixth lens element E6 to the sum of the center thickness of the sixth lens element E6 and the air gap between the sixth lens element E6 and the seventh lens element E7 on the optical axis ensures that parameters such as edge thickness and center thickness of the sixth lens element E6 meet molding requirements, possessing good processability and avoiding appearance of molding defect problems. It can also make the fit between the sixth lens element E6 and the seventh lens element E7 more stable, and better maintain optical performance when subjected to external factors such as vibration and temperature changes, reducing degradation of imaging quality caused by changes in lens element structure and changes in the air gap between the sixth lens element E6 and the seventh lens element E7 on the optical axis.

Preferably, the focusing lens satisfies: 0.43≤ET6/(CT6+T67)≤0.91.

According to some embodiments of the present application, the focusing lens further satisfies: 0.35<ET7/(T67+CT7)<1.10;
wherein ET7 is the maximum thickness of a non-transmissive area of the seventh lens element E7, CT7 is the center thickness of the seventh lens element E7, and T67 is an air gap between the sixth lens element E6 and the seventh lens element E7 on the optical axis.

In this way, similarly, reasonably controlling the ratio of the maximum thickness of the non-transmissive area of the seventh lens element E7 to the sum of the center thickness of the seventh lens element E7 and the air gap between the sixth lens element E6 and the seventh lens element E7 on the optical axis ensures that parameters such as edge thickness and center thickness of the seventh lens element E7 meet molding requirements, possessing good processability and avoiding appearance of molding defect problems. It can also make the fit between the sixth lens element E6 and the seventh lens element E7 more stable, and better maintain optical performance when subjected to external factors such as vibration and temperature changes, reducing degradation of imaging quality caused by changes in lens element structure and changes in the air gap between the sixth lens element E6 and the seventh lens element E7 on the optical axis.

Preferably, the focusing lens satisfies: 0.37≤ET7/(T67+CT7)≤1.08.

According to some embodiments of the present application, the focusing lens satisfies: 1.45<F1/F2<2.45 and −3.60<F1/F3≤−2.10;
wherein F1 is the effective focal length of the first lens element group, F2 is the effective focal length of the second lens element group, and F3 is the effective focal length of the third lens element group.

In this way, reasonably limiting the ratio of the effective focal length of the first lens element group to the effective focal length of the second lens element group, and the ratio of the effective focal length of the first lens element group to the effective focal length of the third lens element group respectively, on one hand helps to balance optical effects among different lens element groups, thereby better correcting aberrations such as spherical aberration and coma, and the first lens element group, the second lens element group, and the third lens element group cooperate with each other to make imaging clearer and sharper. On the other hand, it is conducive to the balance of light propagation and energy distribution, avoiding most light rays focusing on a certain lens element group or excessively diverging on a certain lens element group, which affects overall imaging brightness and contrast, etc.; this can also avoid system design becoming redundant, making full use of the advantages of a plurality of lens element groups to enable reasonably distributed propagation and energy distribution of light rays among the three lens element groups.

Preferably, the focusing lens satisfies: 1.48≤F1/F2≤2.43 and −3.59≤F1/F3≤−2.1.

According to some embodiments of the present application, the focusing lens further satisfies: 1.70≤(T12+T56)/ΔEP0<2.20;
wherein T12 is an air gap between the first lens element E1 and the second lens element E2 on the optical axis, T56 is an air gap between the fifth lens element E5 and the sixth lens element E6 on the optical axis, and ΔEP0 is a distance that the second lens barrel P02 is movable along the direction of the optical axis.

In this way, reasonably controlling the ratio of the sum of the air gap between the first lens element E1 and the second lens element E2 on the optical axis and the air gap between the fifth lens element E5 and the sixth lens element E6 on the optical axis to the maximum distance that the second lens barrel P02 is movable along the direction of the optical axis, on one hand, can ensure that when the lens barrel moves, changes in air gap between lens elements match changes in focal length. When the second lens barrel P02 moves along the direction of the optical axis, by adjusting the air gaps between the first and second lens elements and between the fifth and sixth lens elements, a smooth zoom process is realized, avoiding situations where focal length jumps or imaging quality degrades. On the other hand, distances between the second lens element group and the first lens element group and the third lens element group are controlled to avoid collision during the zoom process, which would damage the lens element groups.

Preferably, the focusing lens satisfies: 1.7≤(T12+T56)/ΔEP0≤2.18.

According to some embodiments of the present application, the focusing lens further satisfies: 4.40<(L1+L2+L3)/ΔEP0<5.55;
wherein L1 is the maximum height of the first lens barrel P01 along the direction of the optical axis, L2 is the maximum height of the second lens barrel P02 along the direction of the optical axis, L3 is the maximum height of the third lens barrel P03 along the direction of the optical axis, and ΔEP0 is the maximum distance that the second lens barrel P02 is movable along the direction of the optical axis.

In this way, reasonably limiting the ratio of the sum of maximum heights of the three lens barrels, i.e., the first lens barrel P01, the second lens barrel P02, and the third lens barrel P03, to the maximum distance that the second lens barrel P02 is movable along the direction of the optical axis can make the mechanical structure of the optical system more compact and improve space utilization. If the ratio is relatively large, that is, the total height of the three lens barrels is too large relative to the maximum distance that the second lens barrel P02 is movable in the direction of the optical axis, the entire system may appear too towering and occupy too much space, which is not conducive to miniaturization and portability of the device; if the ratio is relatively small, the total height of the three lens barrels is relatively low and the moving distance of the second lens barrel P02 is too long, which may make the structure too loose and increase the transverse dimension of the system. Controlling the ratio within this range helps to make the system structure more compact and reasonable on the premise of ensuring optical performance.

Preferably, the focusing lens satisfies: 4.42≤(L1+L2+L3)/ΔEP0≤5.53.

It should be noted that those skilled in the art should understand that without departing from the technical solution claimed in the present application, the number of spacing elements constituting the focusing lens can be changed to obtain various results and advantages described in this specification, and the present application does not make specific limitations on this. For example, according to needs, the focusing lens may also comprise a different number of spacing elements than described in the above embodiments.

Some specific but non-limiting embodiments of the above implementation of the present application are described in more detail below with reference to the accompanying drawings. For ease of description, in the following embodiments, OBJ represents the object plane of the focusing lens, STO represents a surface of an aperture stop, S1 represents the object-side surface of the first lens element E1, S2 represents the image-side surface of the first lens element E1, S3 represents the object-side surface of the second lens element E2, S4 represents the image-side surface of the second lens element E2, S5 represents the object-side surface of the third lens element E3, S6 represents the image-side surface of the third lens element E3, S7 represents the object-side surface of the fourth lens element E4, and S8 represents the image-side surface of the fourth lens element E4; S9 represents the object-side surface of the fifth lens element E5, S10 represents the image-side surface of the fifth lens element E5, S11 represents the object-side surface of the sixth lens element E6, S12 represents the image-side surface of the sixth lens element E6, S13 represents the object-side surface of the seventh lens element E7, S14 represents the image-side surface of the seventh lens element E7, S15 represents the object-side surface of the prism E8, S16 represents the image-side surface of the prism E8, S17 represents the object-side surface of the filter E9, S18 represents the image-side surface of the filter E9, and S19 represents the image plane. In addition, Aj denotes an aspheric coefficient of the j-th order, where j=4, 6, 8, 10, 12, 14, 16, 18, 20, 22, 24, 26, 28, 30.

It is worth noting that the following three embodiments respectively comprise a plurality of configurations, and differences between the plurality of configurations in each embodiment lie in some structural dimensional parameters of lens barrels and spacing elements.

### First Embodiment

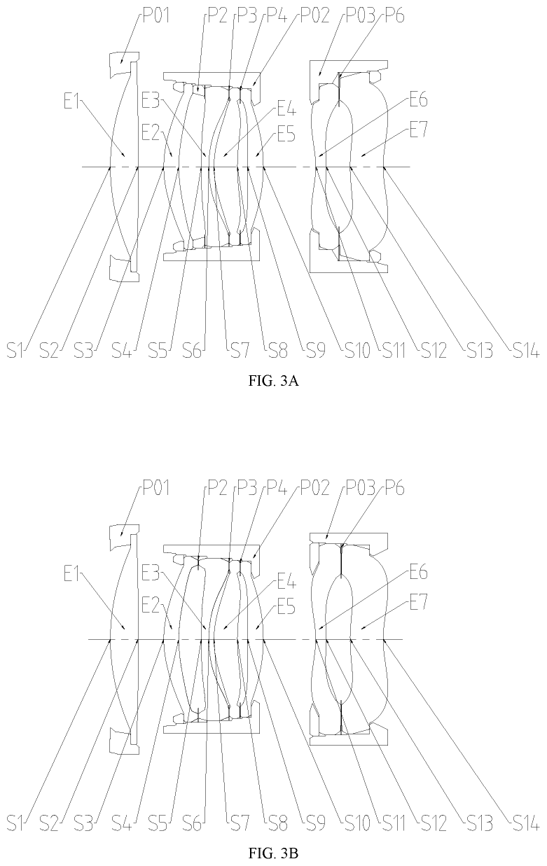

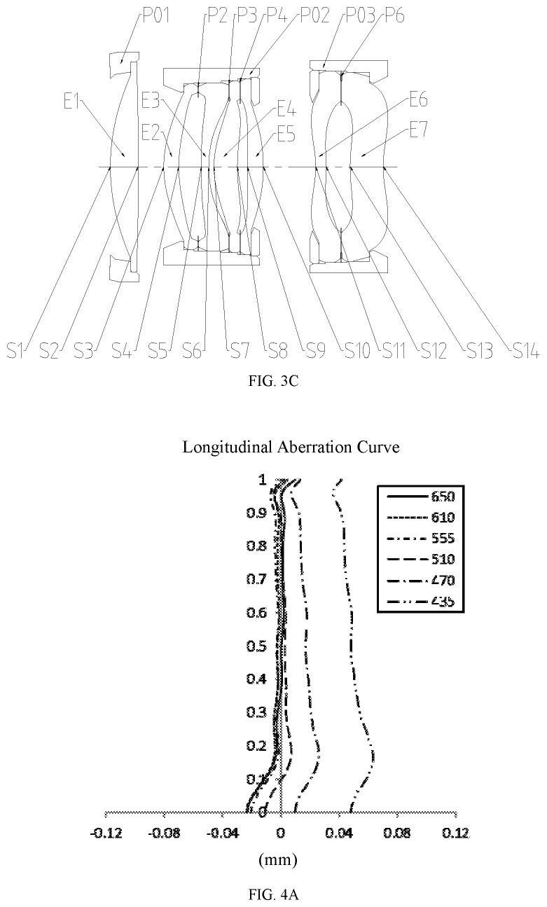

As shown in FIG. 1, FIG. 2, and FIG. 3A to FIG. 3C, wherein FIG. 3A to FIG. 3C are schematic structural diagrams of the focusing lens in three configurations of the first embodiment respectively, in this embodiment, the focusing lens comprises a first lens barrel P01, a second lens barrel P02, and a third lens barrel P03 arranged sequentially along the optical axis from the object side to the image side; the first lens barrel P01 accommodates a first lens element group, and the first lens element group comprises a first lens element E1; the second lens barrel P02 accommodates a second lens element group, and the second lens element group comprises a second lens element E2 to a fifth lens element E5; the third lens barrel P03 accommodates a third lens element group, and the third lens element group comprises a sixth lens element E6 and a seventh lens element E7; refractive powers of the three lens element groups are assigned according to “positive-positive-negative”, and refractive powers of the seven lens elements are assigned according to “positive-positive-negative-positive-positive-negative-negative”.

In this embodiment, any adjacent two lens elements in the second lens element group comprise at least one spacing element therebetween, and a plurality of spacing elements comprise, sequentially from the object side to the image side, a second spacing element P2, a third spacing element P3, and a fourth spacing element P4; the object-side surface and the image-side surface of the second spacing element P2 are respectively in contact with the image-side surface of the second lens element E2 and the object-side surface of the third lens element E3; the object-side surface and the image-side surface of the third spacing element P3 are respectively in contact with the image-side surface of the third lens element E3 and the object-side surface of the fourth lens element E4; and the object-side surface and the image-side surface of the fourth spacing element P4 are respectively in contact with the image-side surface of the fourth lens element E4 and the object-side surface of the fifth lens element E5.

In this embodiment, the third lens element group further comprises a sixth spacing element P6, and the object-side surface and the image-side surface of the sixth spacing element P6 are respectively in contact with the image-side surface of the sixth lens element E6 and the object-side surface of the seventh lens element E7.

In this embodiment, the object-side surface S1 of the first lens element E1 is a convex surface, and the image-side surface S2 thereof is a convex surface; the object-side surface S3 of the second lens element E2 is a convex surface, and the image-side surface S4 thereof is a concave surface; the object-side surface S5 of the third lens element E3 is a convex surface, and the image-side surface S6 thereof is a concave surface; the object-side surface S7 of the fourth lens element E4 is a convex surface, and the image-side surface S8 thereof is a concave surface; the object-side surface S9 of the fifth lens element E5 is a convex surface, and the image-side surface S10 thereof is a convex surface; the object-side surface S11 of the sixth lens element E6 is a concave surface, and the image-side surface S12 thereof is a convex surface; and the object-side surface S13 of the seventh lens element E7 is a convex surface, and the image-side surface S14 thereof is a concave surface.

It is worth noting that in this embodiment, the first lens element E1 is made of a glass material, and the second lens element E2 to the seventh lens element E7 are made of plastic materials, which is conducive to reducing the weight of the entire focusing lens.

In summary, some structural parameters of lens barrels and spacing elements of the focusing lens in the first embodiment in configuration 1-1, configuration 1-2, and configuration 1-3 are as shown in subsequent Table 8.

In addition, Table 1 shows basic optical parameters of the focusing lens of the first embodiment, wherein units of radius of curvature, thickness/distance, and effective radius are all millimeters (mm).

TABLE 1
Basic optical parameter table of the focusing lens of the first embodiment

| Surface | Surface | Radius of | | | | Focal | Conic |
|---|---|---|---|---|---|---|---|
| No. | Type | Curvature | Thickness | Material | | Length | Constant |
| OBJ | Spherical | Infinity | Infinity; 57.8556 | | | | |
| STO | Spherical | Infinity | −5.70E−17 | | | | |
| S1 | Aspheric | 9.9121 | 1.3109 | 1.489 | 70.420 | 19.86 | 0.2612 |
| S2 | Aspheric | −446.0067 | 3.3998; 1.2195 | | | | −99.0000 |
| S3 | Aspheric | 5.1916 | 0.7110 | 1.546 | 55.920 | 34.02 | 0.0000 |
| S4 | Aspheric | 6.8587 | 1.0693 | | | | −0.4295 |
| S5 | Aspheric | 44.3420 | 0.3500 | 1.606 | 28.280 | −9.81 | 0.0000 |
| S6 | Aspheric | 5.2295 | 0.2465 | | | | −0.1490 |
| S7 | Aspheric | 4.2224 | 1.1096 | 1.546 | 55.920 | 13.02 | −0.1175 |
| S8 | Aspheric | 9.4405 | 0.4739 | | | | −2.4631 |
| S9 | Aspheric | 101.3665 | 0.7558 | 1.546 | 55.920 | 12.67 | −99.0000 |
| S10 | Aspheric | −7.4032 | 0.3063; 2.4868 | | | | 1.5600 |
| S11 | Aspheric | −4.0142 | 0.4868 | 1.546 | 55.920 | −11.97 | −1.3520 |
| S12 | Aspheric | −10.8592 | 1.1393 | | | | −55.5479 |
| S13 | Aspheric | 7.3187 | 1.5706 | 1.546 | 55.920 | −80.60 | −2.7078 |
| S14 | Aspheric | 5.7992 | 0.3968 | | | | −6.0422 |
| S15 | Spherical | Infinity | 6.9000 | 1.853 | 23.790 | | |
| S16 | Spherical | Infinity | 0.0300 | | | | |
| S17 | Spherical | Infinity | 0.2100 | 1.518 | 64.170 | | |
| S18 | Spherical | Infinity | 0.7600 | | | | |
| S19 | Spherical | Infinity | | | | | |

It should be explained that the materials in Table 1 comprise the refractive index and an Abbe number; for example, the materials 1.489 and 70.420 for S1 in Table 1 sequentially indicate that the refractive index of the first lens element E1 is 1.489, and the Abbe number thereof is 70.420.

In this embodiment, the object-side surface and the image-side surface of any lens element from the first lens element E1 to the seventh lens element E7 are aspheric surfaces, and the surface profile x of each aspheric lens element can be defined using, but not limited to, the following aspheric formula:

$$x = \frac{{ch}^{2}}{1 + \sqrt{1 - ( k + 1 ) {c}^{2} {h}^{2}}} + \sum {Aih}^{i} ;$$

wherein x is the sag, which is the distance from a point on the aspheric surface at a height h to the vertex of the aspheric surface along the optical axis; c is the paraxial curvature of the aspheric surface, c=1/R (i.e., the paraxial curvature c is the reciprocal of the radius of curvature R in Table 1 above); k is the conic constant; and Ai is the correction coefficient of the i-th order of the aspheric surface. Table 2 below gives high-order term coefficients A4, A6, A8, A10, A12, A14, A16, 18, 20, 22, 24, 26, 28, 30 which can be used for each of the aspheric surfaces S1 to S14 in the first embodiment.

TABLE 2
Aspheric coefficient table of the focusing lens of the first embodiment

| Surface No. | A4 | A6 | A8 | A10 | A12 | A14 | A16 |
|---|---|---|---|---|---|---|---|
| S1 | −7.6980E−05 | 9.7641E−05 | −7.9923E−05 | 3.6298E−05 | −1.0758E−05 | 2.1834E−06 | −3.1224E−07 |
| S2 | 1.1042E−04 | −7.6853E−05 | 3.3479E−05 | −1.0833E−05 | 2.2399E−06 | −2.8593E−07 | 1.9835E−08 |
| S3 | −2.0321E−03 | −1.4431E−04 | −2.4945E−04 | 3.1232E−04 | −1.8961E−04 | 6.9900E−05 | −1.6985E−05 |
| S4 | −3.2715E−03 | −4.6512E−04 | 2.1415E−04 | 1.1125E−04 | −1.6203E−04 | 8.1776E−05 | −2.3976E−05 |
| S5 | −7.4433E−04 | −1.3629E−03 | 5.2244E−03 | −4.1482E−03 | 1.7699E−03 | −4.7859E−04 | 8.6471E−05 |
| S6 | −4.9407E−03 | −4.3413E−03 | 1.0408E−02 | −6.9982E−03 | 2.4082E−03 | −4.1539E−04 | 2.1555E−06 |
| S7 | −7.2020E−03 | −5.0228E−03 | 5.8153E−03 | −2.9208E−03 | 7.4808E−04 | −7.1551E−05 | −1.2780E−05 |
| S8 | 2.2673E−03 | −4.1033E−03 | 9.9145E−04 | 3.3874E−04 | −4.4044E−04 | 1.8077E−04 | −3.6491E−05 |
| S9 | 2.8396E−03 | −2.7100E−03 | 1.3302E−03 | −1.0370E−03 | 8.3200E−04 | −4.9994E−04 | 2.0465E−04 |
| S10 | 2.2133E−03 | −2.6892E−03 | 4.1729E−03 | −4.5164E−03 | 3.2857E−03 | −1.6439E−03 | 5.7783E−04 |
| S11 | 3.3263E−02 | −9.5227E−03 | 5.2471E−03 | −4.2841E−03 | 3.0485E−03 | −1.5794E−03 | 5.8270E−04 |
| S12 | 2.2267E−02 | −5.2967E−03 | 2.5064E−03 | −1.9570E−03 | 1.3789E−03 | −6.9442E−04 | 2.4471E−04 |
| S13 | −1.0706E−02 | 3.1711E−04 | −6.2087E−04 | 8.9900E−04 | −7.2372E−04 | 3.8172E−04 | −1.4027E−04 |
| S14 | −6.6399E−03 | −5.1494E−04 | 5.1324E−04 | −2.3809E−04 | 7.6215E−05 | −1.7533E−05 | 2.9276E−06 |
| Surface No. | A18 | A20 | A22 | A24 | A26 | A28 | A30 |
| S1 | 3.1944E−08 | −2.3463E−09 | 1.2262E−10 | −4.4449E−12 | 1.0612E−13 | −1.4992E−15 | 9.4839E−18 |
| S2 | −1.4151E−10 | −1.1152E−10 | 1.1452E−11 | −5.9578E−13 | 1.8060E−14 | −3.0341E−16 | 2.1920E−18 |
| S3 | 2.8357E−06 | −3.3102E−07 | 2.6988E−08 | −1.5055E−09 | 5.4719E−11 | −1.1664E−12 | 1.1048E−14 |
| S4 | 4.5940E−06 | −6.0061E−07 | 5.4113E−08 | −3.3096E−09 | 1.3126E−10 | −3.0441E−12 | 3.1311E−14 |
| S5 | −1.0509E−05 | 8.2651E−07 | −3.6248E−08 | 2.3532E−10 | 6.2439E−11 | −3.0660E−12 | 4.8588E−14 |
| S6 | 1.6467E−05 | −4.1854E−06 | 5.7167E−07 | −4.8813E−08 | 2.6136E−09 | −8.0773E−11 | 1.1046E−12 |
| S7 | 5.2586E−06 | −8.1574E−07 | 7.1233E−08 | −3.5651E−09 | 8.7136E−11 | −2.5743E−13 | −2.0586E−14 |
| S8 | 2.6702E−06 | 4.0800E−07 | −1.2676E−07 | 1.4962E−08 | −9.6683E−10 | 3.3736E−11 | −4.9938E−13 |
| S9 | −5.6553E−05 | 1.0647E−05 | −1.3682E−06 | 1.1812E−07 | −6.5465E−09 | 2.1004E−10 | −2.9568E−12 |
| S10 | −1.4443E−04 | 2.5752E−05 | −3.2497E−06 | 2.8343E−07 | −1.6249E−08 | 5.5088E−10 | −8.3683E−12 |
| S11 | −1.5382E−04 | 2.9106E−05 | −3.9145E−06 | 3.6516E−07 | −2.2453E−08 | 8.1816E−10 | −1.3379E−11 |
| S12 | −6.1057E−05 | 1.0872E−05 | −1.3770E−06 | 1.2163E−07 | −7.1563E−09 | 2.5350E−10 | −4.1151E−12 |
| S13 | 3.6821E−05 | −6.9524E−06 | 9.3683E−07 | −8.7860E−08 | 5.4448E−09 | −2.0026E−10 | 3.3078E−12 |
| S14 | −3.5601E−07 | 3.1380E−08 | −1.9733E−09 | 8.5738E−11 | −2.4242E−12 | 3.9617E−14 | −2.7801E−16 |

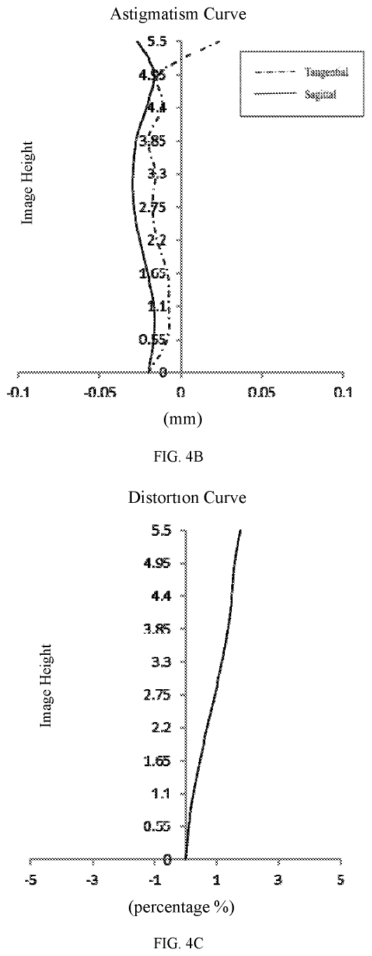

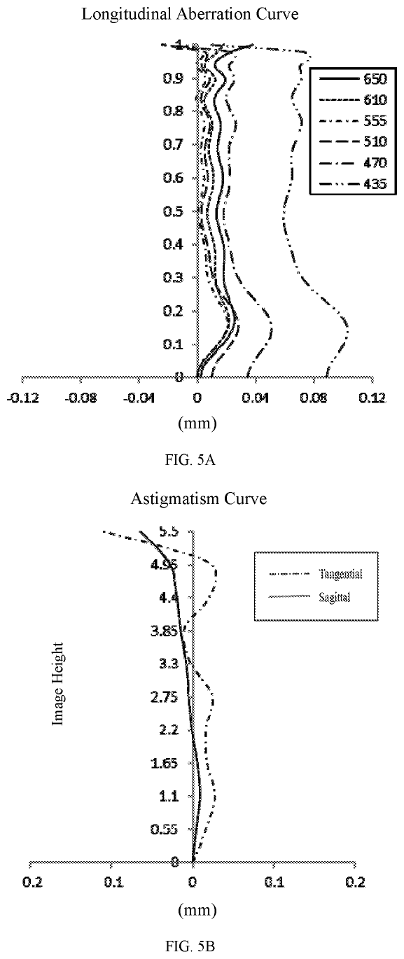

As shown in FIG. 4A to FIG. 4C and FIG. 5A to FIG. 5C, FIG. 4A to FIG. 4C are respectively an axial chromatic aberration curve, an astigmatism curve, and a distortion curve of the focusing lens of the first embodiment when the object distance is infinity, and FIG. 5A to FIG. 5C are respectively an axial chromatic aberration curve, an astigmatism curve, and a distortion curve of the focusing lens of the first embodiment when the object distance is 57.8556 mm. According to FIG. 4A to FIG. 4C and FIG. 5A to FIG. 5C, it can be seen that the focusing lens according to the first embodiment has good optical performance and imaging effects.

### Second Embodiment

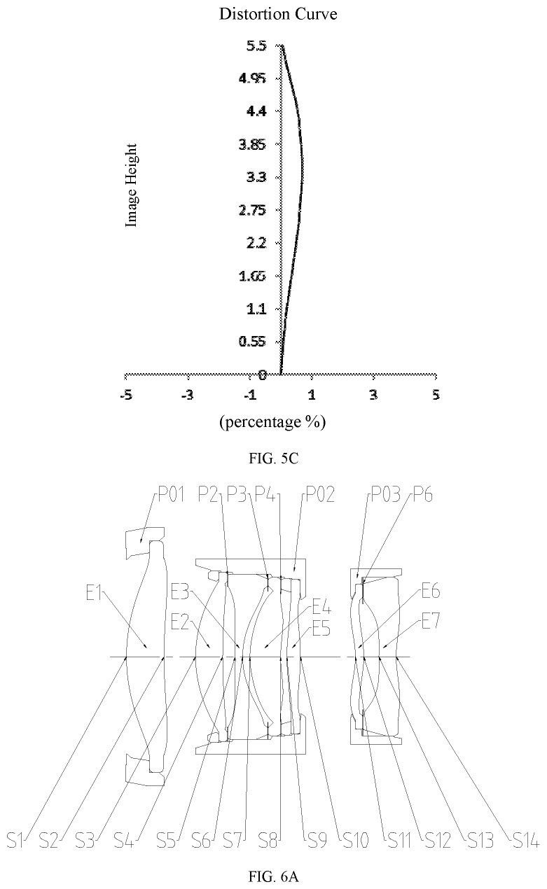

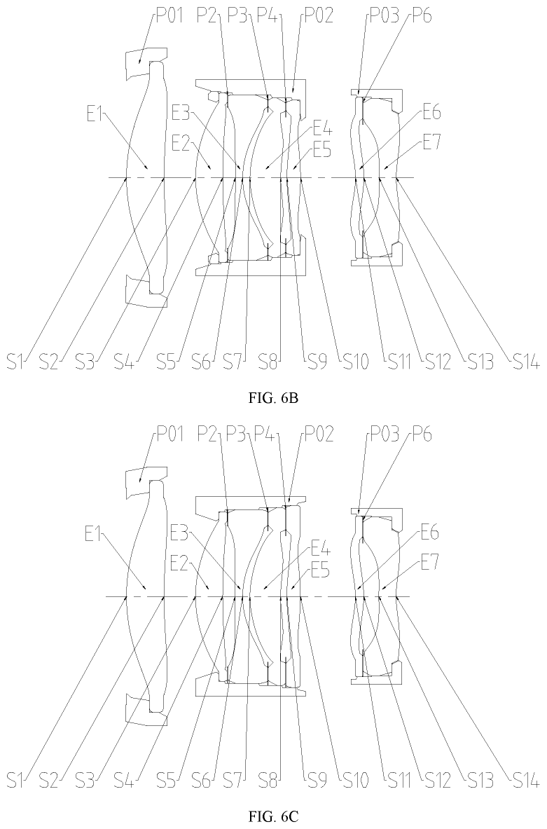

As shown in FIG. 1, FIG. 2, and FIG. 6A to FIG. 6C, FIG. 6A to FIG. 6C are schematic structural diagrams of the focusing lens in three configurations of the second embodiment respectively, in this embodiment, the focusing lens comprises a first lens barrel P01, a second lens barrel P02, and a third lens barrel P03 arranged sequentially along the optical axis from the object side to the image side; the first lens barrel P01 accommodates a first lens element group, wherein the first lens element group comprises a first lens element E1; the second lens barrel P02 accommodates a second lens element group, wherein the second lens element group comprises a second lens element E2 to a fifth lens element E5; the third lens barrel P03 accommodates a third lens element group, wherein the third lens element group comprises a sixth lens element E6 and a seventh lens element E7; refractive powers of the three lens element groups are assigned according to “positive-positive-negative”, and refractive powers of the seven lens elements are assigned according to “positive-positive-negative-positive-positive-negative-negative”.

In this embodiment, any adjacent two lens elements in the second lens element group comprise at least one spacing element therebetween, and a plurality of spacing elements comprise, sequentially from the object side to the image side, a second spacing element P2, a third spacing element P3, and a fourth spacing element P4; the object-side surface and the image-side surface of the second spacing element P2 are respectively in contact with the image-side surface of the second lens element E2 and the object-side surface of the third lens element E3; the object-side surface and the image-side surface of the third spacing element P3 are respectively in contact with the image-side surface of the third lens element E3 and the object-side surface of the fourth lens element E4; and the object-side surface and the image-side surface of the fourth spacing element P4 are respectively in contact with the image-side surface of the fourth lens element E4 and the object-side surface of the fifth lens element E5.

In this embodiment, the third lens element group further comprises a sixth spacing element P6, and the object-side surface and the image-side surface of the sixth spacing element P6 are respectively in contact with the image-side surface of the sixth lens element E6 and the object-side surface of the seventh lens element E7.

In this embodiment, the object-side surface S1 of the first lens element E1 is a convex surface, and the image-side surface S2 thereof is a concave surface; the object-side surface S3 of the second lens element E2 is a convex surface, and the image-side surface S4 thereof is a concave surface; the object-side surface S5 of the third lens element E3 is a concave surface, and the image-side surface S6 thereof is a concave surface; the object-side surface S7 of the fourth lens element E4 is a convex surface, and the image-side surface S8 thereof is a concave surface; the object-side surface S9 of the fifth lens element E5 is a convex surface, and the image-side surface S10 thereof is a convex surface; the object-side surface S11 of the sixth lens element E6 is a concave surface, and the image-side surface S12 thereof is a convex surface; and the object-side surface S13 of the seventh lens element E7 is a convex surface, and the image-side surface S14 thereof is a concave surface.

It is worth noting that in this embodiment, the first lens element E1 is made of a glass material, and the second lens element E2 to the seventh lens element E7 are made of plastic materials, which is conducive to reducing the weight of the entire focusing lens.

In summary, some structural parameters of lens barrels and spacing elements of the focusing lens in the second embodiment in configuration 2-1, configuration 2-2, and configuration 2-3 are as shown in subsequent Table 8.

In addition, Table 3 shows basic optical parameters of the focusing lens of the second embodiment, wherein units of radius of curvature, thickness/distance, and effective radius are all millimeters (mm).

TABLE 3
Basic optical parameter table of the focusing lens of the second embodiment

| Surface | Surface | Radius of | | | | Focal | Conic |
|---|---|---|---|---|---|---|---|
| No. | Type | Curvature | Thickness | Material | | Length | Constant |
| OBJ | Spherical | Infinity | Infinity; 52.6455 | | | | |
| STO | Spherical | Infinity | 3.74E−17 | | | | |
| S1 | Aspheric | 8.1447 | 1.7841 | 1.498 | 81.56 | 23.41 | 0.3134 |
| S2 | Aspheric | 25.0308 | 3.5992; 1.4934 | | | | 10.2823 |
| S3 | Aspheric | 5.696 | 1.2873 | 1.546 | 56.14 | 13.11 | 0.0104 |
| S4 | Aspheric | 25.6501 | 0.5961 | | | | 24.4207 |
| S5 | Aspheric | −100.3649 | 0.35 | 1.619 | 25.93 | −6.40 | 0.0000 |
| S6 | Aspheric | 4.1285 | 0.3454 | | | | 0.0000 |
| S7 | Aspheric | 4.3437 | 1.4556 | 1.57 | 37.4 | 19.71 | −0.1352 |
| S8 | Aspheric | 6.2212 | 0.2944 | | | | −0.0310 |
| S9 | Aspheric | 8.3127 | 0.6433 | 1.57 | 37.4 | 7.97 | 1.2011 |
| S10 | Aspheric | −9.726 | 0.5000; 2.6058 | | | | 0.2474 |
| S11 | Aspheric | −3.974 | 0.3952 | 1.546 | 56.14 | −68.86 | 0.0000 |
| S12 | Aspheric | −4.5999 | 0.7182 | | | | 0.3710 |
| S13 | Aspheric | 20.4214 | 0.8169 | 1.546 | 56.14 | −10.15 | −99.0000 |
| S14 | Aspheric | 4.2951 | 0.4412 | | | 23.41 | 0.4249 |
| S15 | Spherical | Infinity | 5.8031 | 1.856 | 40.12 | | |
| S16 | Spherical | Infinity | 0.0252 | | | | |
| S17 | Spherical | Infinity | 0.1766 | 1.518 | 64.17 | | |
| S18 | Spherical | Infinity | 0.6392 | | | | |
| S19 | Spherical | Infinity | | | | | |

It should be explained that the materials in Table 3 comprise the refractive index and an Abbe number; for example, the materials 1.498 and 81.56 for S1 in Table 3 sequentially indicate that the refractive index of the first lens element E1 is 1.498, and the Abbe number thereof is 81.56.

In this embodiment, the object-side surface and the image-side surface of any lens element from the first lens element E1 to the seventh lens element E7 are aspheric surfaces, and the surface profile x of each aspheric lens element can be defined using, but not limited to, the following aspheric formula:

$$x = \frac{{ch}^{2}}{1 + \sqrt{1 - ( k + 1 ) {c}^{2} {h}^{2}}} + \sum {Aih}^{i} ;$$

wherein x is the sag, which is the distance from a point on the aspheric surface at a height h to the vertex of the aspheric surface along the optical axis; c is the paraxial curvature of the aspheric surface, c=1/R (i.e., the paraxial curvature c is the reciprocal of the radius of curvature R in Table 1 above); k is the conic constant; and Ai is the correction coefficient of the i-th order of the aspheric surface. Table 4 below gives high-order term coefficients A4, A6, A8, A10, A12, A14, A16, 18, 20, 22, 24, 26, 28, 30 which can be used for each of the aspheric surfaces S1 to S14 in the second embodiment.

TABLE 4
Aspheric coefficient table of the focusing lens of the second embodiment

| Surface No. | A4 | A6 | A8 | A10 | A12 | A14 | A16 |
|---|---|---|---|---|---|---|---|
| S1 | −4.2769E−04 | 1.0623E−04 | −8.6148E−05 | 3.8802E−05 | −1.1601E−05 | 2.3827E−06 | −3.4514E−07 |
| S2 | −5.3139E−04 | −3.1099E−05 | 1.2839E−05 | −5.3943E−06 | 1.3589E−06 | −2.2156E−07 | 2.3664E−08 |
| S3 | −1.5357E−03 | 2.7372E−04 | −3.5865E−04 | 2.9702E−04 | −1.5289E−04 | 5.3011E−05 | −1.2968E−05 |
| S4 | −2.9907E−03 | 5.1339E−04 | 9.0920E−05 | 9.1991E−05 | −1.3955E−04 | 6.7452E−05 | −1.8104E−05 |
| S5 | 4.6686E−03 | −7.2086E−03 | 8.9607E−03 | −6.2215E−03 | 2.6080E−03 | −7.1582E−04 | 1.3306E−04 |
| S6 | 7.4856E−03 | −1.4306E−02 | 1.5930E−02 | −1.0234E−02 | 3.8716E−03 | −8.5646E−04 | 8.3737E−05 |
| S7 | −2.6074E−03 | −6.1655E−03 | 5.1921E−03 | −2.0014E−03 | 1.6847E−04 | 1.9014E−04 | −1.0089E−04 |
| S8 | −8.6348E−03 | −6.6798E−03 | 2.5702E−03 | −1.5580E−05 | −6.6757E−04 | 4.5304E−04 | −1.6505E−04 |
| S9 | −3.9988E−04 | −4.9967E−03 | 1.4169E−03 | −4.5485E−04 | 4.4072E−04 | −4.2946E−04 | 2.5797E−04 |
| S10 | 5.9981E−03 | −2.7434E−03 | 4.6361E−03 | −5.7497E−03 | 4.7653E−03 | −2.7149E−03 | 1.0877E−03 |
| S11 | 3.3218E−02 | −1.1366E−02 | 1.1297E−02 | −1.2302E−02 | 1.0157E−02 | −6.0107E−03 | 2.5566E−03 |
| S12 | 2.6299E−02 | −8.6023E−03 | 9.4784E−03 | −1.1326E−02 | 9.9339E−03 | −6.1514E−03 | 2.7174E−03 |
| S13 | −3.2651E−02 | 4.4648E−03 | −2.0875E−03 | 3.6309E−03 | −4.1106E−03 | 2.9904E−03 | −1.4996E−03 |
| S14 | −3.6030E−02 | 4.6241E−03 | 1.7678E−03 | −2.3699E−03 | 1.4753E−03 | −6.3087E−04 | 1.9641E−04 |
| Surface No. | A18 | A20 | A22 | A24 | A26 | A28 | A30 |
| S1 | 3.5773E−08 | −2.6619E−09 | 1.4096E−10 | −5.1811E−12 | 1.2558E−13 | −1.8041E−15 | 1.1633E−17 |
| S2 | −1.5789E−09 | 5.1977E−11 | 7.6177E−13 | −1.5910E−13 | 7.0798E−15 | −1.4863E−16 | 1.2643E−18 |
| S3 | 2.2923E−06 | −2.9491E−07 | 2.7400E−08 | −1.7926E−09 | 7.8364E−11 | −2.0536E−12 | 2.4372E−14 |
| S4 | 3.0325E−06 | −3.2189E−07 | 2.0201E−08 | −5.2831E−10 | −1.5834E−11 | 1.4808E−12 | −3.0105E−14 |
| S5 | −1.6693E−05 | 1.3402E−06 | −5.6239E−08 | −3.1072E−10 | 1.6529E−10 | −7.6813E−12 | 1.2350E−13 |
| S6 | 9.3542E−06 | −4.5967E−06 | 7.6845E−07 | −7.4108E−08 | 4.3347E−09 | −1.4343E−10 | 2.0687E−12 |
| S7 | 2.6695E−05 | −4.4814E−06 | 5.0325E−07 | −3.7782E−08 | 1.8232E−09 | −5.1180E−11 | 6.3567E−13 |
| S8 | 3.8615E−05 | −6.1584E−06 | 6.8390E−07 | −5.2683E−08 | 2.7208E−09 | −8.5839E−11 | 1.2628E−12 |
| S9 | −9.5436E−05 | 2.2751E−05 | −3.5809E−06 | 3.7069E−07 | −2.4284E−08 | 9.1149E−10 | −1.4895E−11 |
| S10 | −3.0887E−04 | 6.2132E−05 | −8.7661E−06 | 8.4581E−07 | −5.2984E−08 | 1.9342E−09 | −3.1070E−11 |
| S11 | −7.8695E−04 | 1.7536E−04 | −2.8004E−05 | 3.1238E−06 | −2.3113E−07 | 1.0194E−08 | −2.0284E−10 |
| S12 | −8.6537E−04 | 1.9912E−04 | −3.2808E−05 | 3.7751E−06 | −2.8817E−07 | 1.3115E−08 | −2.6940E−10 |
| S13 | 5.3461E−04 | −1.3666E−04 | 2.4864E−05 | −3.1410E−06 | 2.6167E−07 | −1.2918E−08 | 2.8612E−10 |
| S14 | −4.5047E−05 | 7.5832E−06 | −9.2288E−07 | 7.8809E−08 | −4.4698E−09 | 1.5095E−10 | −2.2938E−12 |

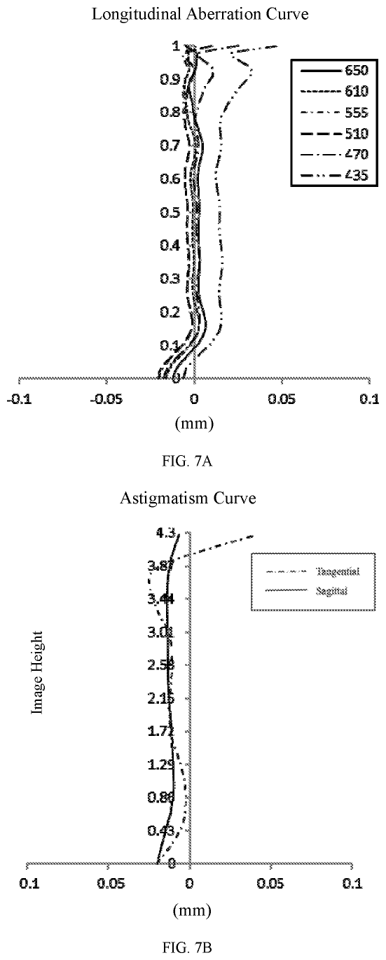

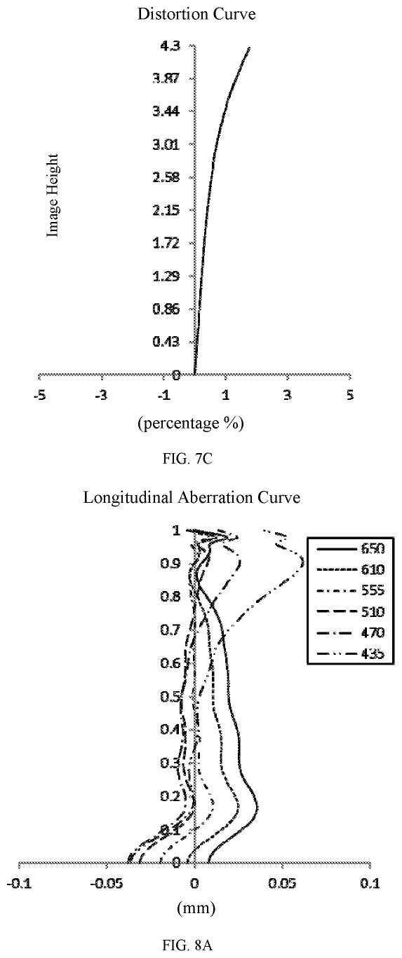

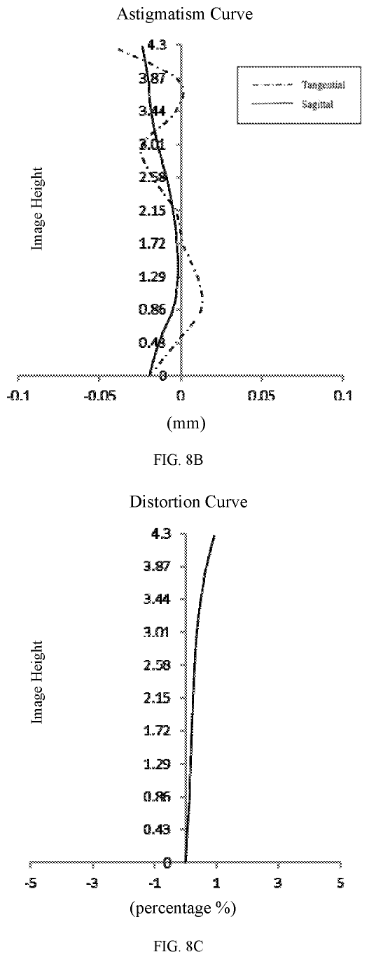

As shown in FIG. 7A to FIG. 7C and FIG. 8A to FIG. 8C, FIG. 7A to FIG. 7C are respectively an axial chromatic aberration curve, an astigmatism curve, and a distortion curve of the focusing lens of the second embodiment when the object distance is infinity, and FIG. 8A to FIG. 8C are respectively an axial chromatic aberration curve, an astigmatism curve, and a distortion curve of the focusing lens of the second embodiment when the object distance is 52.6455 mm. According to FIG. 7A to FIG. 7C and FIG. 8A to FIG. 8C, it can be seen that the focusing lens according to the second embodiment has good optical performance and imaging effects.

### Third Embodiment

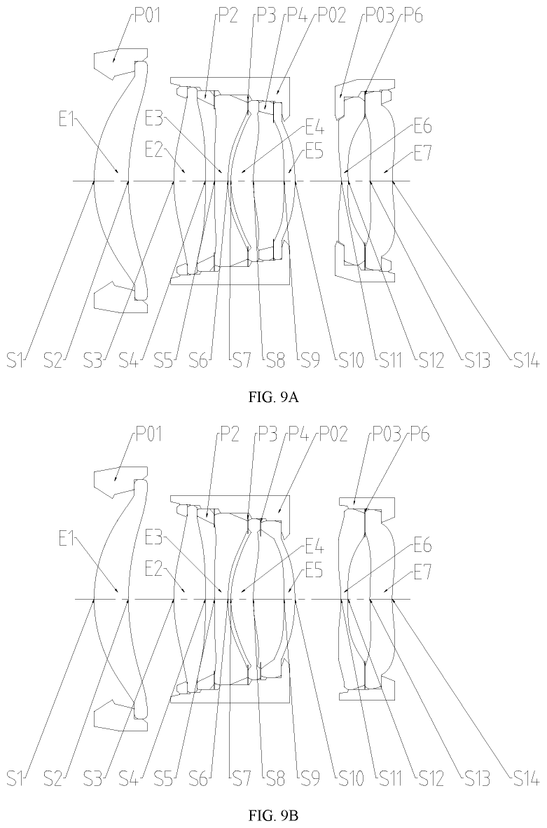

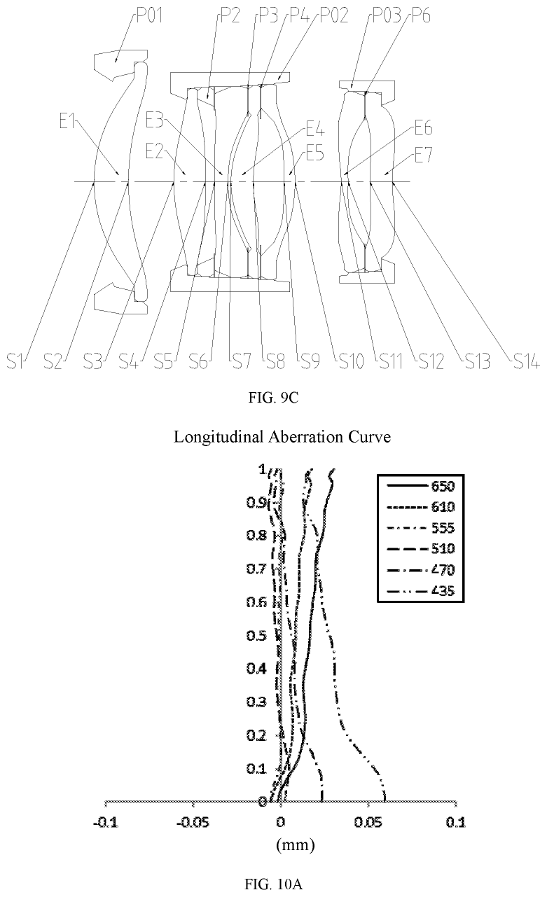

As shown in FIG. 1, FIG. 2, and FIG. 9A to FIG. 9C, FIG. 9A to FIG. 9C are schematic structural diagrams of the focusing lens in three configurations of the third embodiment respectively, in this embodiment, the focusing lens comprises a first lens barrel P01, a second lens barrel P02, and a third lens barrel P03 arranged sequentially along the optical axis from the object side to the image side; the first lens barrel P01 accommodates a first lens element group, wherein the first lens element group comprises a first lens element E1; the second lens barrel P02 accommodates a second lens element group, wherein the second lens element group comprises a second lens element E2 to a fifth lens element E5; the third lens barrel P03 accommodates a third lens element group, wherein the third lens element group comprises a sixth lens element E6 and a seventh lens element E7; refractive powers of the three lens element groups are assigned according to “positive-positive-negative”, and refractive powers of the seven lens elements are assigned according to “positive-positive-negative-positive-positive-negative-negative”.

In this embodiment, any adjacent two lens elements in the second lens element group comprise at least one spacing element therebetween, and a plurality of spacing elements comprise, sequentially from the object side to the image side, a second spacing element P2, a third spacing element P3, and a fourth spacing element P4; the object-side surface and the image-side surface of the second spacing element P2 are respectively in contact with the image-side surface of the second lens element E2 and the object-side surface of the third lens element E3; the object-side surface and the image-side surface of the third spacing element P3 are respectively in contact with the image-side surface of the third lens element E3 and the object-side surface of the fourth lens element E4; and the object-side surface and the image-side surface of the fourth spacing element P4 are respectively in contact with the image-side surface of the fourth lens element E4 and the object-side surface of the fifth lens element E5.

In this embodiment, the third lens element group further comprises a sixth spacing element P6, and the object-side surface and the image-side surface of the sixth spacing element P6 are respectively in contact with the image-side surface of the sixth lens element E6 and the object-side surface of the seventh lens element E7.

In this embodiment, the object-side surface S1 of the first lens element E1 is a convex surface, and the image-side surface S2 thereof is a concave surface; the object-side surface S3 of the second lens element E2 is a convex surface, and the image-side surface S4 thereof is a convex surface; the object-side surface S5 of the third lens element E3 is a concave surface, and the image-side surface S6 thereof is a concave surface; the object-side surface S7 of the fourth lens element E4 is a convex surface, and the image-side surface S8 thereof is a concave surface; the object-side surface S9 of the fifth lens element E5 is a concave surface, and the image-side surface S10 thereof is a convex surface; the object-side surface S11 of the sixth lens element E6 is a concave surface, and the image-side surface S12 thereof is a convex surface; and the object-side surface S13 of the seventh lens element E7 is a convex surface, and the image-side surface S14 thereof is a concave surface.

It is worth noting that in this embodiment, the first lens element E1 is made of a glass material, and the second lens element E2 to the seventh lens element E7 are made of plastic materials, which is conducive to reducing the weight of the entire focusing lens.

In summary, some structural parameters of lens barrels and spacing elements of the focusing lens in the third embodiment in configuration 3-1, configuration 3-2, and configuration 3-3 are as shown in subsequent Table 8.

In addition, Table 5 shows basic optical parameters of the focusing lens of the third embodiment, wherein units of radius of curvature, thickness/distance, and effective radius are all millimeters (mm).

TABLE 5
Basic optical parameter table of the focusing lens of the third embodiment

| Surface | Surface | Radius of | | | | Focal | Conic |
|---|---|---|---|---|---|---|---|
| No. | Type | Curvature | Thickness | Material | | Length | Constant |
| OBJ | Spherical | Infinity | Infinity; 66.6675 | | | | |
| STO | Spherical | Infinity | −0.8958 | | | | |
| S1 | Aspheric | 6.7954 | 1.6691 | 1.489 | 70.420 | 30.02 | 0.0491 |
| S2 | Aspheric | 11.6362 | 4.2463; 2.2043 | | | | 1.1107 |
| S3 | Aspheric | 7.8704 | 1.5366 | 1.546 | 56.140 | 13.40 | −0.3414 |
| S4 | Aspheric | −96.1941 | 0.4483 | | | | −99.0000 |
| S5 | Aspheric | −158.3315 | 0.6490 | 1.606 | 28.280 | −9.75 | −99.0000 |
| S6 | Aspheric | 6.1497 | 0.1400 | | | | 0.3232 |
| S7 | Aspheric | 3.9405 | 1.0896 | 1.546 | 56.140 | 15.06 | −0.0922 |
| S8 | Aspheric | 6.8293 | 1.4937 | | | | −0.4442 |
| S9 | Aspheric | −29.3461 | 0.5299 | 1.546 | 56.140 | 18.54 | 99.0000 |
| S10 | Aspheric | −7.5722 | 0.2018; 2.2438 | | | | 3.6413 |
| S11 | Aspheric | −4.6979 | 0.3400 | 1.546 | 56.140 | −12.21 | −1.6935 |
| S12 | Aspheric | −16.3212 | 1.0552 | | | | −93.6010 |
| S13 | Aspheric | 12.6226 | 1.0893 | 1.546 | 56.140 | −33.51 | 6.8311 |
| S14 | Aspheric | 7.2410 | 0.3114 | | | | −2.6350 |
| S15 | Spherical | Infinity | 6.9000 | 1.853 | 23.790 | | |
| S16 | Spherical | Infinity | 0.0300 | | | | |
| S17 | Spherical | Infinity | 0.2100 | 1.518 | 64.170 | | |
| S18 | Spherical | Infinity | 0.7600 | | | | |
| S19 | Spherical | Infinity | | | | | |

It should be explained that the materials in Table 5 comprise the refractive index and an Abbe number; for example, the materials 1.489 and 70.420 for S1 in Table 5 sequentially indicate that the refractive index of the first lens element E1 is 1.489, and the Abbe number thereof is 70.420.

In this embodiment, the object-side surface and the image-side surface of any lens element from the first lens element E1 to the seventh lens element E7 are aspheric surfaces, and the surface profile x of each aspheric lens element can be defined using, but not limited to, the following aspheric formula:

$$x = \frac{{ch}^{2}}{1 + \sqrt{1 - ( k + 1 ) {c}^{2} {h}^{2}}} + \sum {Aih}^{i} ;$$

wherein x is the sag, which is the distance from a point on the aspheric surface at a height h to the vertex of the aspheric surface along the optical axis; c is the paraxial curvature of the aspheric surface, c=1/R (i.e., the paraxial curvature c is the reciprocal of the radius of curvature R in Table 1 above); k is the conic constant; and Ai is the correction coefficient of the i-th order of the aspheric surface. Table 6 below gives high-order term coefficients A4, A6, A8, A10, A12, A14, A16, 18, 20, 22, 24, 26, 28, 30 which can be used for each of the aspheric surfaces S1 to S14 in the third embodiment.

TABLE 6
Aspheric coefficient table of the focusing lens of the third embodiment

| Surface No. | A4 | A6 | A8 | A10 | A12 | A14 | A16 |
|---|---|---|---|---|---|---|---|
| S1 | −1.6121E−04 | 1.9077E−05 | −1.5712E−05 | 6.4946E−06 | −1.7568E−06 | 3.2306E−07 | −4.1636E−08 |
| S2 | −2.3894E−04 | 2.4523E−05 | −1.9087E−05 | 8.0235E−06 | −2.2552E−06 | 4.3679E−07 | −5.9649E−08 |
| S3 | −1.5614E−03 | 7.7737E−06 | 4.2266E−05 | −4.8675E−05 | 2.3879E−05 | −7.1361E−06 | 1.4253E−06 |
| S4 | −8.0924E−03 | 4.6000E−03 | −2.2544E−03 | 8.0753E−04 | −2.1305E−04 | 4.1363E−05 | −5.8943E−06 |
| S5 | −1.1005E−02 | 1.7336E−02 | −1.1553E−02 | 5.1793E−03 | −1.6836E−03 | 4.0346E−04 | −7.1744E−05 |
| S6 | −3.5174E−02 | 5.1001E−02 | −3.9837E−02 | 2.1584E−02 | −8.6075E−03 | 2.5852E−03 | −5.9236E−04 |
| S7 | −3.7033E−02 | 4.0319E−02 | −3.2376E−02 | 1.8386E−02 | −7.7512E−03 | 2.4851E−03 | −6.1213E−04 |
| S8 | −4.2491E−03 | 4.0079E−04 | −5.1660E−04 | 1.9767E−04 | −5.8297E−05 | 2.8334E−05 | −1.5421E−05 |
| S9 | −1.0854E−03 | 7.8777E−04 | −1.6432E−03 | 1.3374E−03 | −7.4581E−04 | 2.8908E−04 | −8.0027E−05 |
| S10 | 9.4447E−04 | 7.4417E−04 | −8.9753E−04 | 3.8780E−04 | 2.1956E−05 | −1.2598E−04 | 7.5812E−05 |
| S11 | 4.1272E−02 | −9.1987E−03 | −2.4429E−03 | 4.9288E−03 | −3.5691E−03 | 1.6720E−03 | −5.5301E−04 |
| S12 | 3.7351E−02 | −5.2322E−03 | −5.4904E−03 | 7.0524E−03 | −4.7041E−03 | 2.1182E−03 | −6.7995E−04 |
| S13 | −1.0466E−02 | −1.4727E−05 | 1.0534E−03 | −9.5245E−04 | 5.3144E−04 | −1.9707E−04 | 4.9727E−05 |
| S14 | −1.1584E−02 | 1.1891E−03 | −2.0333E−04 | 5.9180E−05 | −2.4879E−05 | 9.3748E−06 | −2.5945E−06 |
| Surface No. | A18 | A20 | A22 | A24 | A26 | A28 | A30 |
| S1 | 3.8255E−09 | −2.5191E−10 | 1.1800E−11 | −3.8379E−13 | 8.2374E−15 | −1.0489E−16 | 6.0004E−19 |
| S2 | 5.8166E−09 | −4.0626E−10 | 2.0153E−11 | −6.9297E−13 | 1.5700E−14 | −2.1075E−16 | 1.2698E−18 |
| S3 | −1.9768E−07 | 1.9324E−08 | −1.3281E−09 | 6.2832E−11 | −1.9493E−12 | 3.5718E−14 | −2.9314E−16 |
| S4 | 6.1389E−07 | −4.6281E−08 | 2.4768E−09 | −9.0751E−11 | 2.1297E−12 | −2.8022E−14 | 1.4765E−16 |
| S5 | 9.4857E−06 | −9.2918E−07 | 6.6623E−08 | −3.4069E−09 | 1.1803E−10 | −2.4903E−12 | 2.4215E−14 |
| S6 | 1.0404E−04 | −1.3935E−05 | 1.3970E−06 | −1.0116E−07 | 4.9720E−09 | −1.4769E−10 | 1.9925E−12 |
| S7 | 1.1574E−04 | −1.6600E−05 | 1.7636E−06 | −1.3362E−07 | 6.7872E−09 | −2.0614E−10 | 2.8197E−12 |
| S8 | 5.7434E−06 | −1.3836E−06 | 2.1832E−07 | −2.2481E−08 | 1.4567E−09 | −5.3945E−11 | 8.7093E−13 |
| S9 | 1.6243E−05 | −2.4710E−06 | 2.8490E−07 | −2.4495E−08 | 1.4780E−09 | 5.5054E−11 | 9.3670E−13 |
| S10 | −2.5255E−05 | 5.4247E−06 | −7.8203E−07 | 7.5562E−08 | −4.7172E−09 | 1.7292E−10 | −2.8448E−12 |
| S11 | 1.3259E−04 | −2.3180E−05 | 2.9293E−06 | −2.6089E−07 | 1.5542E−08 | −5.5611E−10 | 9.0355E−12 |
| S12 | 1.5833E−04 | −2.6798E−05 | 3.2615E−06 | −2.7795E−07 | 1.5733E−08 | −5.3106E−10 | 8.0844E−12 |
| S13 | −8.5448E−06 | 9.7062E−07 | −6.6137E−08 | 1.7482E−09 | 9.0490E−11 | −8.4695E−12 | 1.9775E−13 |
| S14 | 5.0510E−07 | −6.8782E−08 | 6.5050E−09 | −4.1805E−10 | 1.7387E−11 | −4.2132E−13 | 4.5050E−15 |

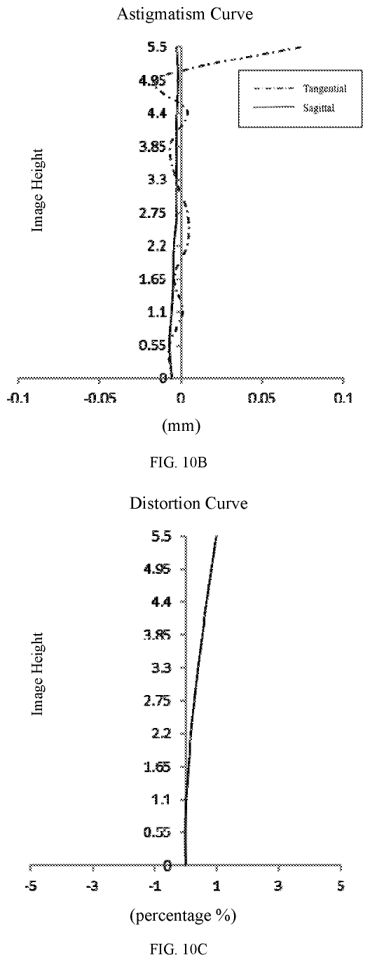

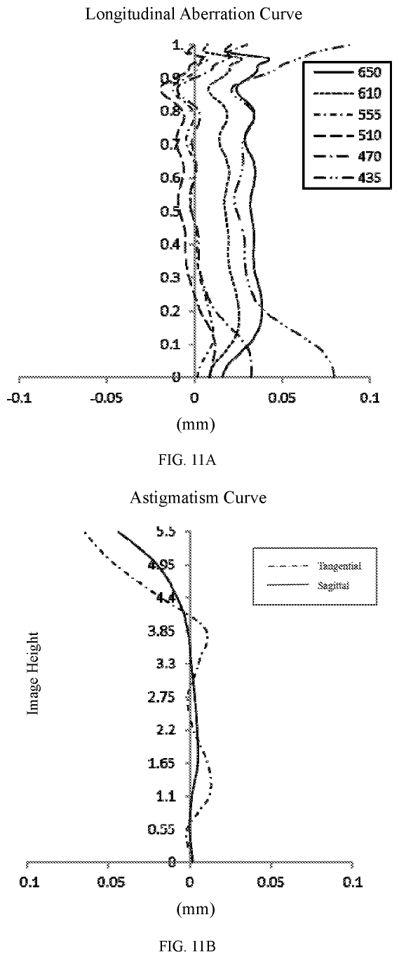

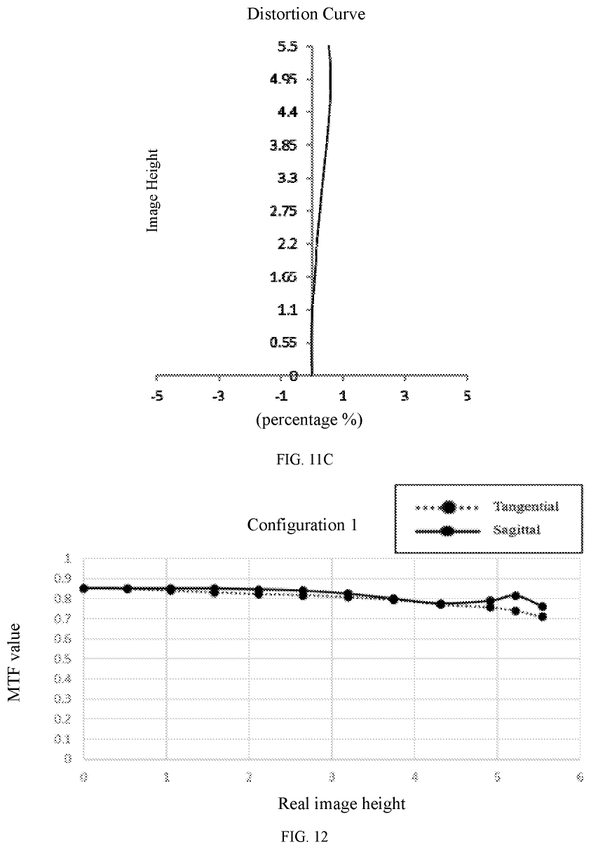

As shown in FIG. 10A to FIG. 10C and FIG. 11A to FIG. 11C, FIG. 10A to FIG. 10C are respectively an axial chromatic aberration curve, an astigmatism curve, and a distortion curve of the focusing lens of the third embodiment when the object distance is infinity, and FIG. 11A to FIG. 11C are respectively an axial chromatic aberration curve, an astigmatism curve, and a distortion curve of the focusing lens of the third embodiment when the object distance is 66.6675 mm. According to FIG. 10A to FIG. 10C and FIG. 11A to FIG. 11C, it can be seen that the focusing lens according to the third embodiment has good optical performance and imaging effects.

In summary, in the first embodiment to the third embodiment, effective focal lengths F1 to F3 of the first lens element group to the third lens element group in the focusing lens, the effective focal length f of the focusing lens at the object distance of infinity and at a close distance respectively, and an aperture number Fno of the focusing lens are as shown in Table 7 below respectively.

TABLE 7
System optical parameter table of the focusing lens

| Optical Parameters | Object Distance | 1 | 2 | 3 |
|---|---|---|---|---|
| F1 (mm) | / | 19.86 | 23.41 | 30.02 |
| F2 (mm) | / | 13.43 | 11.56 | 12.35 |
| F3 (mm) | / | −9.47 | −8.44 | −8.37 |
| f (mm) | Infinity | 16.79 | 15.22 | 18.89 |
| | Close Distance | 11.99 | 10.68 | 13.02 |
| Fno | Infinity | 2.00 | 1.65 | 1.93 |
| | Close Distance | 2.35 | 2.12 | 2.37 |

In addition, partial structural parameters of the lens barrels and spacing elements of the focusing lens in the first embodiment to the third embodiment (DT2s, DT2m, d2s, d3s, d4m, L1, L2, L3, ΔEP0, ET6, ET7) are specifically shown in Table 8.

TABLE 8
Partial structural parameter table of the focusing lens

| Structural Parameter | 1-1 | 1-2 | 1-3 | 2-1 | 2-2 | 2-3 | 3-1 | 3-2 | 3-3 |
|---|---|---|---|---|---|---|---|---|---|
| DT2s | 7.0541 | 7.0541 | 7.0541 | 7.1828 | 7.1828 | 7.1828 | 8.0501 | 8.0501 | 8.0501 |
| DT2m | 5.7798 | 5.7798 | 5.7798 | 5.4093 | 5.4093 | 9.0274 | 5.7809 | 5.7809 | 9.7741 |
| d2s | 7.0425 | 6.5719 | 6.5719 | 6.6956 | 6.6956 | 6.6956 | 8.1121 | 8.1121 | 8.1312 |
| d3s | 6.2512 | 6.2512 | 6.2512 | 6.2254 | 6.2254 | 6.2254 | 6.3996 | 6.3996 | 6.3996 |
| d4m | 6.0286 | 6.0286 | 6.0286 | 5.9728 | 5.7622 | 5.7622 | 6.4718 | 6.1639 | 6.1639 |
| L1 | 1.3902 | 1.3902 | 1.3902 | 1.8173 | 1.9631 | 1.9631 | 2.5882 | 2.5882 | 2.5882 |
| L2 | 4.5488 | 4.5488 | 4.5488 | 5.2232 | 5.2232 | 5.2232 | 5.7895 | 5.7895 | 5.7895 |
| L3 | 3.7050 | 3.7050 | 3.7050 | 2.4141 | 2.4146 | 2.4146 | 2.9147 | 2.6974 | 2.6974 |
| ΔEP0 | 2.1803 | 2.1803 | 2.1803 | 2.1058 | 2.1058 | 2.1058 | 2.0420 | 2.0420 | 2.0420 |
| ET6 | 1.2078 | 1.3061 | 1.3061 | 0.4737 | 0.4737 | 0.4737 | 1.2706 | 1.2706 | 1.2706 |
| ET7 | 1.4402 | 1.3419 | 1.3419 | 1.6567 | 1.3648 | 1.6567 | 0.7988 | 0.7988 | 0.7988 |

In summary, the focusing lens in the first embodiment to the third embodiment satisfy the relational expressions shown in Table 9:

TABLE 9
Table of relational expressions satisfied by the focusing lens

| Conditional Expression/ | | | | | | | | | |
|---|---|---|---|---|---|---|---|---|---|
| Embodiment | 1-1 | 1-2 | 1-3 | 2-1 | 2-2 | 2-3 | 3-1 | 3-2 | 3-3 |
| (F1 + F2 + F3)/Δf | 4.97 | 4.97 | 4.97 | 5.84 | 5.84 | 5.84 | 5.79 | 5.79 | 5.79 |
| (DT2s + DT2m)/Td2 | 2.72 | 2.72 | 2.72 | 2.53 | 2.53 | 3.26 | 2.35 | 2.35 | 2.35 |
| F2/L2 | 2.95 | 2.95 | 2.95 | 2.21 | 2.21 | 2.21 | 2.13 | 2.13 | 2.13 |
| F2/Td2 | 2.85 | 2.85 | 2.85 | 2.32 | 2.32 | 2.32 | 2.10 | 2.10 | 2.10 |
| f2/d2s | 4.83 | 5.18 | 5.18 | 1.96 | 1.96 | 1.96 | 1.65 | 1.65 | 1.65 |
| (f3 + f4)/d3s | 0.51 | 0.51 | 0.51 | 2.14 | 2.14 | 2.14 | 0.83 | 0.83 | 0.83 |
| f4/d4m | 2.16 | 2.16 | 2.16 | 3.30 | 3.42 | 3.42 | 2.33 | 2.44 | 2.44 |
| DT2m/(CT5N5) | 4.95 | 4.95 | 4.95 | 5.36 | 5.36 | 8.94 | 7.06 | 7.06 | 11.93 |
| DT2s/(CT2N5) | 6.42 | 6.42 | 6.42 | 3.61 | 3.61 | 3.61 | 3.39 | 3.39 | 3.39 |
| F3/L3 | −2.55 | −2.55 | −2.55 | −3.49 | −3.49 | −3.49 | −2.87 | −3.10 | −3.10 |
| Td3/L3 | 0.86 | 0.86 | 0.86 | 0.80 | 0.80 | 0.80 | 0.85 | 0.92 | 0.92 |
| \|F3\|/(L3 − T67) | 3.69 | 3.69 | 3.69 | 4.97 | 4.97 | 4.97 | 4.50 | 5.10 | 5.10 |
| ET6/(CT6 + T67) | 0.74 | 0.80 | 0.80 | 0.43 | 0.43 | 0.43 | 0.91 | 0.91 | 0.91 |
| ET7/(T67 + CT7) | 0.53 | 0.50 | 0.50 | 1.08 | 0.89 | 1.08 | 0.37 | 0.37 | 0.37 |
| F1/F2 | 1.48 | 1.48 | 1.48 | 2.03 | 2.03 | 2.03 | 2.43 | 2.43 | 2.43 |
| F1/F3 | −2.10 | −2.10 | −2.10 | −2.78 | −2.78 | −2.78 | −3.59 | −3.59 | −3.59 |
| DT2s/DT2m | 1.22 | 1.22 | 1.22 | 1.33 | 1.33 | 0.80 | 1.39 | 1.39 | 0.82 |
| (T12 + T56)/ΔEP0 | 1.70 | 1.70 | 1.70 | 1.95 | 1.95 | 1.95 | 2.18 | 2.18 | 2.18 |
| (L1 + L2 + L3)/ΔEP0 | 4.42 | 4.42 | 4.42 | 4.49 | 4.56 | 4.56 | 5.53 | 5.42 | 5.42 |

The technical features of the above embodiments can be combined arbitrarily. For the sake of brevity of description, not all possible combinations of the technical features in the above embodiments have been described. However, as long as there is no contradiction in the combinations of these technical features, they should be considered as within the scope recorded in this specification.

The above embodiments only express several implementations of the present application, and the descriptions thereof are relatively specific and detailed, but they cannot be understood as a limitation on the patent scope of the application. It should be pointed out that for those of ordinary skill in the art, several deformations and improvements can be made without departing from the concept of the present application, all of which belong to the protection scope of the present application. Therefore, the protection scope of the patent of the present application shall be subject to the appended claims.

What is claimed is:

1. A focusing lens, comprising:
a first lens barrel, a second lens barrel, and a third lens barrel arranged sequentially along an optical axis, wherein the second lens barrel is movably disposed between the first lens barrel and the third lens barrel;
a first lens element group disposed in the first lens barrel, the first lens element group comprising a first lens element having positive refractive power;
a second lens element group disposed in the second lens barrel, the second lens element group having positive refractive power and comprising a second lens element having positive refractive power, a third lens element having negative refractive power, a fourth lens element having positive refractive power, and a fifth lens element having positive refractive power;
a third lens element group disposed in the third lens barrel, the third lens element group having negative refractive power and comprising a sixth lens element having negative refractive power and a seventh lens element having negative refractive power;
wherein any adjacent two lens elements in the second lens element group comprise at least one spacing element therebetween, and the object-side surface of the spacing element is in contact with an adjacent lens element;
wherein the focusing lens satisfies:
4.95<(F1+F2+F3)/|Δf|<5.85; and
2.35≤(DT2s+DT2m)/Td2≤3.30;
wherein F1 is the effective focal length of the first lens element group, F2 is the effective focal length of the second lens element group, and F3 is the effective focal length of the third lens element group; Δf is a change of the effective focal length of the focusing lens when the second lens barrel moves from a position closest to the first lens barrel to a position closest to the third lens barrel; DT2s is the clear aperture of the second lens barrel at the object side, and DT2m is the clear aperture of the second lens barrel at the image side; and Td2 is a distance on the optical axis from the object-side surface of the second lens element to the image-side surface of the fifth lens element in the second lens element group.

2. The focusing lens according to claim 1, wherein the second lens barrel satisfies:
0.80≤DT2s/DT2m<1.40.

3. The focusing lens according to claim 1, wherein the focusing lens satisfies:
2.10<F2/L2≤2.95; and
2.10≤F2/Td2≤2.85;
wherein L2 is the maximum height of the second lens barrel.

4. The focusing lens according to claim 1, wherein a second spacing element is disposed at the image side of the second lens element and in contact with the image-side surface of the second lens element, and the focusing lens further satisfies:
1.65≤f2/d2s<5.20;
wherein f2 is the effective focal length of the second lens element, and d2s is the inner diameter of the object-side surface of the second spacing element.

5. The focusing lens according to claim 1, wherein a third spacing element is disposed at the image side of the third lens element and in contact with the image-side surface of the third lens element, and the focusing lens further satisfies:
0.50<(f3+f4)/d3s<2.15;
wherein f3 is the effective focal length of the third lens element, f4 is the effective focal length of the fourth lens element, and d3s is the inner diameter of the object-side surface of the third spacing element.

6. The focusing lens according to claim 1, wherein a fourth spacing element is disposed at the image side of the fourth lens element and in contact with the image-side surface of the fourth lens element, and the focusing lens further satisfies:
2.15<f4/d4m<3.45;
wherein f4 is the effective focal length of the fourth lens element, and d4m is the inner diameter of the image-side surface of the fourth spacing element.

7. The focusing lens according to claim 1, wherein the focusing lens further satisfies:
4.95≤DT2m/(CT5×N5)<11.95;
wherein CT5 is the center thickness of the fifth lens element, and N5 is the refractive index of the fifth lens element.

8. The focusing lens according to claim 1, wherein the focusing lens further satisfies:
3.35<DT2s/(CT2×N2)<6.45;
wherein CT2 is the center thickness of the second lens element, and N2 is the refractive index of the second lens element.

9. The focusing lens according to claim 1, wherein the focusing lens satisfies:
−3.50<F3/L3≤−2.55; and
0.80≤Td3/L3<0.95;
wherein L3 is the maximum height of the third lens barrel along the direction of the optical axis, and Td3 is a distance on the optical axis from the object-side surface of the sixth lens element to the image-side surface of the seventh lens element in the third lens element group.

10. The focusing lens according to claim 1, wherein the focusing lens further satisfies:
3.65<|F3|/(L3−T67)≤5.10;
wherein L3 is the maximum height of the third lens barrel along the direction of the optical axis, and T67 is an air gap between the sixth lens element and the seventh lens element on the optical axis.

11. The focusing lens according to claim 1, wherein the focusing lens further satisfies:
0.40<ET6/(CT6+T67)<0.95;
wherein ET6 is the maximum thickness of a non-transmissive area of the sixth lens element, CT6 is the center thickness of the sixth lens element, and T67 is an air gap between the sixth lens element and the seventh lens element on the optical axis.

12. The focusing lens according to claim 1, wherein the focusing lens further satisfies:
0.35<ET7/(T67+CT7)<1.10;
wherein ET7 is the maximum thickness of a non-transmissive area of the seventh lens element, CT7 is the center thickness of the seventh lens element, and T67 is an air gap between the sixth lens element and the seventh lens element on the optical axis.

13. The focusing lens according to claim 1, wherein the focusing lens satisfies:
1.45<F1/F2<2.45; and
−3.60<F1/F3≤−2.10.

14. The focusing lens according to claim 1, wherein the focusing lens further satisfies:
1.70≤(T12+T56)/ΔEP0<2.20;
wherein T12 is an air gap between the first lens element and the second lens element on the optical axis, T56 is an air gap between the fifth lens element and the sixth lens element on the optical axis, and ΔEP0 is the maximum distance that the second lens barrel is movable along the direction of the optical axis.

15. The focusing lens according to claim 1, wherein the focusing lens further satisfies:
4.40<(L1+L2+L3)/ΔEP0<5.55;
wherein L1 is the maximum height of the first lens barrel along the direction of the optical axis, L2 is the maximum height of the second lens barrel along the direction of the optical axis, L3 is the maximum height of the third lens barrel along the direction of the optical axis, and ΔEP0 is the maximum distance that the second lens barrel is movable along the direction of the optical axis.
